SEQUENCE LISTING (5 sequences)

SEQ ID NO: 1 - DNA, 9 bp, Artificial Sequence
  Description of Artificial Sequence note = synthetic construct
ctcatcagc

SEQ ID NO: 2 - RNA, 58 nt, Artificial Sequence
  Description of Artificial Sequence note = synthetic construct
gggcgacccugaugagcuugaguuunucaggcgaaacggugaaagccguagguugccc

SEQ ID NO: 3 - RNA, 26 nt, Artificial Sequence
  Description of Artificial Sequence note = synthetic construct
gggcgacccugaugagcuugaguuun

SEQ ID NO: 4 - RNA, 34 nt, Artificial Sequence
  Description of Artificial Sequence note = synthetic construct
naucaggcgaaacggugaaagccguagguugccc

SEQ ID NO: 5 - DNA, 17 bp, Artificial Sequence
  Description of Artificial Sequence note = synthetic construct
taatacgactcactata

(19) United States
(12) Patent Application Publication
(10) Pub. No.: US 2011/0288826 A1
(43) Pub. Date: Nov. 24, 2011

(54) COMPUTATIONAL DESIGN OF RIBOZYMES

(76) Inventors: Ronald R. Breaker, Guilford, CT (US); Robert Penchovsky, Sofia (BG)

(21) Appl. No.: 12/446,188

(22) PCT Filed: Oct. 19, 2007
(86) PCT No.: PCT/US07/81973

§ 371 Date: Jun. 22, 2011

Related U.S. Application Data
(60) Provisional application No. 60/852,951, filed on Oct. 19, 2006.

(51) Int. Cl. G06F 17/50; G06F 7/60

(52) U.S. Cl. 703/2

(57) ABSTRACT

Disclosed herein are methods, processes, and computer programs related to the design of ribozymes.

### CROSS-REFERENCE TO RELATED APPLICATIONS

This application claims benefit of U.S. Provisional Application No. 60/852,951, filed Oct. 19, 2006. U.S. Provisional Application No. 60/852,951, filed Oct. 19, 2006, is hereby incorporated herein by reference in its entirety.

### STATEMENT REGARDING FEDERALLY SPONSORED RESEARCH

This invention was made with government support under a grant awarded by the National Science Foundation; a grant awarded by DARPA; and Grant No. N01-HV-28186 awarded by the NIH. The government has certain rights in the invention.

### FIELD OF THE INVENTION

The disclosed invention is generally in the field of nucleic acid design.

### BACKGROUND OF THE INVENTION

Precision genetic control is an essential feature of living systems, as cells must respond to a multitude of biochemical signals and environmental cues by varying genetic expression patterns. Most known mechanisms of genetic control involve the use of protein factors that sense chemical or physical stimuli and then modulate gene expression by selectively interacting with the relevant DNA or messenger RNA sequence. Proteins can adopt complex shapes and carry out a variety of functions that permit living systems to sense accurately their chemical and physical environments. Protein factors that respond to metabolites typically act by binding DNA to modulate transcription initiation (e.g. the lac repressor protein; Matthews, K. S., and Nichols, J. C., 1998, Prog. Nucleic Acids Res. Mol. Biol. 58, 127-164) or by binding RNA to control either transcription termination (e.g. the PyrR protein; Switzer, R. L., et al., 1999, Prog. Nucleic Acids Res. Mol. Biol. 62, 329-367) or translation (e.g. the TRAP protein; Babitzke, P., and Gollnick, P., 2001, J. Bacteriol. 183, 5795-5802). Protein factors respond to environmental stimuli by various mechanisms such as allosteric modulation or post-translational modification, and are adept at exploiting these mechanisms to serve as highly responsive genetic switches (e.g. see Ptashne, M., and Gann, A. (2002). Genes and Signals. Cold Spring Harbor Laboratory Press, Cold Spring Harbor, N.Y.).

Although proteins fulfill most requirements that biology has for enzyme, receptor and structural functions, RNA also can serve in these capacities. For example, RNA has sufficient structural plasticity to form numerous ribozyme domains (Cech & Golden, Building a catalytic active site using only RNA. In: The RNA World R. F. Gesteland, T. R. Cech, J. F. Atkins, eds., pp.321-350 (1998); Breaker, In vitro selection of catalytic polynucleotides. Chem. Rev. 97, 371-390 (1997)) and receptor domains (Osborne & Ellington, Nucleic acid selection and the challenge of combinatorial chemistry. Chem. Rev. 97, 349-370 (1997); Hermann & Patel, Adaptive recognition by nucleic acid aptamers. Science 287, 820-825 (2000)) that exhibit considerable enzymatic power and precise molecular recognition. Furthermore, these activities can be combined to create allosteric ribozymes (Soukup & Breaker, Engineering precision RNA molecular switches. Proc. Natl. Acad. Sci. USA 96, 3584-3589 (1999); Seetharaman et al., immobilized riboswitches for the analysis of complex chemical and biological mixtures. Nature Biotechnol. 19, 336-341 (2001)) that are selectively modulated by effector molecules.

The detection of specific chemical and biological compounds can be achieved with structured RNAs that form selective binding pockets for their target ligands (Breaker 2004). These ligand-binding domains, or aptamers (Gold 1995; Osborne 1997) can be used independently (Hamaguchi 2001; McCauley 2003; Bock 2004) or can be joined with other functional RNA domains (Soukup 2000; Silverman 2003; Soukup 1999) to serve as molecular reporter systems that selectively bind targets and signal their presence to the user. For example, aptamers have been judiciously coupled to catalytic RNA domains to form allosteric ribozymes whose activities in many cases are modulated by several orders of magnitude upon ligand (or ‘effector’) binding (Soukup 2000).

The potential utility of allosteric ribozymes has been demonstrated by the construction of prototype RNA sensor arrays that have been used to detect specific proteins, small molecules and metal ions that are present even in complex biological mixtures (Seetharaman 2001; Hesselberth 2003). Furthermore, it has been discovered that numerous natural RNA switches, or riboswitches, exist in many bacteria (Nahvi 2002; Winkler 2002a; Mironov 2002; Winkler 2002b) and in some higher organisms (Sudarsan 2003; Kubodera 2003), where they serve as metabolite-sensing gene control elements (Winkler 2003; Vitreschak 2004; Mandal 2004). The fact that modern organisms rely on riboswitches shows that nucleic acids provide a robust medium for the construction of such functional macromolecules. Indeed, novel allosteric RNAs can be engineered for a broad range of practical applications in areas such as gene therapy (Lewin 2001; Schubert 2004), designer gene control systems (Westruck 1998; Grate 2001; Thompson 2002; Suess 2004; Desai 2004), biosensors (Seetharaman 2001; Hesselberth 2003; Breaker 2002; Ferguson 2004; Srinivasan 2004) and molecular computation (Stojanovic 2003a; Stojanovic 2003b; Stojanovic 2004).

The fusion of aptamers with ribozymes to create RNA switches most commonly has been achieved by modular rational design (Tang 1997; Jose 2001), or by blending modular rational design with in vitro evolution techniques (Soukup 1999; Koizumi 1999; Robertson 2004). Modular rational design approaches are most effective for designing oligonucleotide-responsive ribozymes (Porta 1995; Komatsu 2000; Burke 2002) or deoxyribozymes (Stojanovic 2002; Wang 2002), largely because the rules that govern molecular recognition and structural characteristics of Watson-Crick base-paired interactions are well understood. However, it remains problematic to design allosteric nucleic acids that exhibit robust activation, that are triggered without introducing denaturation and reannealing steps and that process to near completion.

What is needed in the art is a computational strategy for designing new ribozyme constructs that exhibit robust activation upon the addition of specific ligands, such as oligonucleotides.

### BRIEF SUMMARY OF THE INVENTION

Disclosed herein is a method for designing a nucleic acid switch, the method comprising: a) generating a random oligonucleotide binding sequence; b) generating a potential nucleic acid switch for molecular computing, wherein the potential nucleic acid switch comprises core sequences and the oligonucleotide binding sequence, wherein a nucleic acid consisting of the core sequences can form a predetermined active structure; c) utilizing an algorithm to predict secondary structure of the potential nucleic acid switch; d) determining if a predetermined portion of the core sequences forms a predetermined structure in the predicted secondary structure of step (c); e) if the predetermined structure of step (d) is formed, then utilizing an algorithm to predict secondary structure of the potential nucleic acid switch with the oligonucelotide binding sequences replaced with nucleotides defined to have no binding properties, otherwise, repeating steps (a) through (e); f) determining if the predicted secondary structure comprises a predetermined active structure; g) if the predetermined active structure of step (f) is formed, then generating a new potential nucleic acid switch comprising the same core sequences and a new random oligonucleotide binding sequence, wherein the new potential nucleic acid switch forms a similar predicted secondary as the predicted secondary structure of step (c), otherwise, repeating steps (a) through (g); h) determining if a predetermined portion of the core sequences forms a predetermined structure in the predicted secondary structure of step (c); i) if the predetermined structure of step (h) is formed, then computing the thermodynamic stability of the predicted secondary structure of step (h), otherwise, repeating steps (a) through (i); j) if the thermodynamic stability of step (i) differs by more than a threshold value from the thermodynamic stability of the predicted secondary structure of step (c), repeat steps (a) through (j); k) computing the thermodynamic stability of the oligonucleotide binding sequence of step (g) when bound to a perfectly matched complementary RNA; 1) if the thermodynamic stability of step (k) differs by more than a threshold value from the thermodynamic stability of the oligonucleotide binding sequence of step (a) when bound to a perfectly matched complementary RNA, repeat steps (a) through (1); and m) producing a nucleic acid switch comprising the sequence of the new potential nucleic acid switch of step (g).

Also disclosed is a method of designing nucleic acid switch, comprising: generating an RNA library of potential nucleic acid switches for molecular computing; utilizing an algorithm to predict secondary structure of the potential nucleic acid switches in the presence and absence of a target ligand; determining the difference in the secondary structure of the RNA in the presence and the absence of the target ligand; comparing the difference in the secondary structure in the presence and absence of the target ligand to a standard; and selecting those potential nucleic acid switches which meet the standard; thereby designing a nucleic acid switch. The nucleic acid switch can be a riboswitch. The algorithm can be a partition function algorithm. Thermodynamic search parameters can be used in the algorithm. RNAfold source code from the Vienna RNA folding package can be used in the algorithm. Base-pairing probabilities for the RNA and target ligand can be computed. The target ligand can be an oligonucleotide.

The RNA can form a dominant secondary structure in the absence of the target ligand and a different secondary structure in the presence of the target ligand. The RNA can form a dominant secondary structure in the presence of the target ligand and a different secondary structure in the absence of the target ligand. The RNA can form a dominant secondary structure in the absence of two distinct target ligands, and a different secondary structure in the presence of both distinct target ligands. The presence of only one of the distinct target ligands may not cause the RNA to form a different secondary structure. The RNA can form a dominant secondary structure in the absence of both of two distinct target ligands, and a different secondary structure in the presence of one or the other target ligands.

The algorithm can compute one or more possible secondary structures for the RNA molecule. The secondary structures can be computed as a function of temperature. The potential ribozyme can have a modular architecture. The modular architecture can allow an oligonucleotide binding site to be computationally altered. After identifying a potential ribozyme, sequences found in the oligonucleotide binding site of the potential ribozyme can be varied, thereby designing a second library of potential ribozymes. The potential ribozyme can be a hammerhead ribozyme.

Also disclosed is a computer program embodied on a computer-readable medium for designing a ribozyme, comprising an algorithm to predict secondary structure of an RNA molecule in the presence and absence of a target ligand. The program can be further able to vary the sequences of the oligonucleotide binding site of the potential ribozyme.

Also disclosed is a process embodied in an instruction signal of a computing device for generating a potential ribozyme, comprising an algorithm to predict secondary structure of an RNA molecule in the presence and absence of a target ligand.

### BRIEF DESCRIPTION OF THE DRAWINGS

The accompanying drawings, which are incorporated in and constitute a part of this specification, illustrate several embodiments of the disclosed method and compositions and together with the description, serve to explain the principles of the disclosed method and compositions.

FIG. 1 shows (a) parental hammerhead ribozyme sequence (Tang 1997; Jose 2001; Soukup 1999; Koizumi 1999) used to create ligand-responsive ribozyme switches. Numbering systems for the hammerhead is as described in Hertel et al. (1992, incorporated by reference in its entirety for its teaching concerning hammerhead numbering systems), where stems I through III represent base-paired structures that are essential for ribozyme function. The arrowhead identifies the site of ribozyme self-cleavage. (b) Integration of one (left) or two (right) oligonucleotide binding sites (OBS) into stem II of the parent hammerhead depicted in a. (c) Extended hammerhead ribozyme that exhibits faster RNA cleavage rates with low Mg2+ concentrations (Osborne 2005). (d) Integration of an OBS in stem I of the extended ribozyme to create RNA switches with NOT function.

FIG. 2 shows (a) secondary structure models for the most stable conformers as computed using the partition function algorithm in the absence (OFF) or presence (ON) of a 22-nucleotide DNA effector. The effector-binding site (bold) is joined to nucleotides 10.1 and 11.1 of the hammerhead core via eight- and six-nucleotide linkers. In the ON state, most of these linker nucleotides are predicted to form an extended stem II structure (light grey). To the right of each model is a dot matrix plot wherein larger points reflect greater probability of base pairing. Encircled points reflect the main differences in predicted structures between the OFF (stem IV) and ON (stem II) states. Nucleotides 1 through 79 are numbered from 5′ to 3′ across the top and right of the plots. Schematic representations of the logic states of the constructs are shown in this and subsequent figures. (b) Selective activation of ribozyme self-cleavage by an effector DNA complementary to the OBS. Radiolabeled ribozymes (5′ 32P, Pre) undergo self-cleavage only with the perfectly matched DNA effector (0 mismatches) and the resulting radiolabeled cleavage fragment (Clv) is separated from the precursor by denaturing 10% PAGE. Products were visualized and cleavage yields were quantified by Phosphorlmager. (c) Kinetics of ribozyme (1 M) self-cleavage in the presence (+) of perfectly matched 22-nt effector DNA (3 M) and in the absence (−) of effector DNA. Gel image is as described in b. Plot using data derived from the gel depicts the natural logarithm of the fraction of RNA remaining uncleaved versus time.

FIG. 3 shows (a) secondary structure models for the most stable conformers in the absence (OFF) or presence (ON) of a 22-nucleotide DNA effector complementary to the changed OBS. (b) Selective activation of YES-2 self-cleavage by effector DNAs complementary to the OBS. (c) Kinetics of YES-2 self-cleavage in the presence of perfectly matched 22-nt effector DNA and in the absence of effector.

FIG. 4 shows (a) secondary structure models for the most stable conformers predicted in the absence (ON) and presence (OFF) of a 23-nucleotide effector. (b) Deactivation of NOT-1 by a DNA complementary to the OBS.

FIG. 5 shows (a) AND-1 is designed to form the active hammerhead structure and self-cleave only when presented simultaneously with its two corresponding effector DNAs (DNA-7 and DNA-8). The dot matrix plots for the ON state showing some character of the OFF states (stem IV) is depicted. (b) Activation of AND-1 self-cleavage requires both full-length DNA-7 and DNA-8 effectors. Maximum incubation time is 60 min. (c) Kinetics of AND-1 self-cleavage under various combinations of effector DNAs.

FIG. 6 shows a) OR-1 is designed to trigger self-cleavage when either effector (DNA-9 or DNA-10) or both effectors are present. (b) Activation of OR-1 self-cleavage occurs when either or both effectors are present when incubated for 5 min under standard assay conditions. (c) Kinetics of OR-1 self-cleavage in the absence of effector and in the presence of both effector DNAs.

FIG. 7 shows a) nucleotides of the YES-2 variant RNA that differ from YES-2 are depicted. Upon activation of YES-2 variant by effector DNA-2, the 3′ cleavage fragment (RNA-1) is released and serves as an effector for YES-1 activation. (b) Assay depicting function of a ribozyme-signaling pathway. YES-1 RNAs are radiolabeled in all lanes. Ribozymes and effector DNAs are present as defined at concentrations of 1 and 3 μM, respectively, and reactions were incubated at 23° C. for 5 min. (c) Kinetic analysis of YES-1 self-cleavage in the presence of YES-2 variant and its effector DNA-2. Details are as described in b.

### DETAILED DESCRIPTION OF THE INVENTION

The disclosed methods can be understood more readily by reference to the following detailed description of particular embodiments and the Examples included therein and to the Figures and their previous and following description.

Disclosed are materials, compositions, and components that can be used for, can be used in conjunction with, can be used in preparation for, or are products of the disclosed methods and computer-related programs and devices thereof. These and other materials are disclosed herein, and it is understood that when combinations, subsets, interactions, groups, etc. of these materials are disclosed that while specific reference to each of various individual and collective combinations and permutation of these compounds can not be explicitly disclosed, each is specifically contemplated and described herein. For example, if a ribozyme is disclosed and discussed and a number of modifications that can be made to a number of molecules including the ribozyme domain are discussed, each and every combination and permutation of ribozyme and the modifications that are possible are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

### A. Ribozymes in General

Although proteins traditionally have been used for catalysis of nucleic acids, another class of macromolecules has emerged as useful in this endeavor. Ribozymes are RNA-protein complexes that cleave nucleic acids in a site-specific fashion. Ribozymes have specific catalytic domains that possess endonuclease activity (Kim and Cech, 1987; Gerlach et al., 1987; Forster and Symons, 1987). For example, a large number of ribozymes accelerate phosphoester transfer reactions with a high degree of specificity, often cleaving only one of several phosphoesters in an oligonucleotide substrate (Cech et al., 1981; Michel and Westhof, 1990; Reinhold-Hurek and Shub, 1992). This specificity has been attributed to the requirement that the substrate bind via specific base-pairing interactions to the oligonucleotide binding site, OBS, of the ribozyme prior to chemical reaction.

Ribozyme catalysis has primarily been observed as part of sequence-specific cleavage/ligation reactions involving nucleic acids (Joyce, 1989; Cech et al., 1981). For example, U.S. Pat. No. 5,354,855 (specifically incorporated herein by reference) reports that certain ribozymes can act as endonucleases with a sequence specificity greater than that of known ribonucleases and approaching that of the DNA restriction enzymes. Thus, sequence-specific ribozyme-mediated inhibition of gene expression can be particularly suited to therapeutic applications (Scanlon et al., 1991; Sarver et al., 1990). Recently, it was reported that ribozymes elicited genetic changes in some cells lines to which they were applied; the altered genes included the oncogenes H-ras, c-fos and genes of HIV. Most of this work involved the modification of a target mRNA, based on a specific mutant codon that is cleaved by a specific ribozyme.

Six basic varieties of naturally occurring enzymatic RNAs are known presently. Each can catalyze the hydrolysis of RNA phosphodiester bonds in trans (and thus can cleave other RNA molecules) under physiological conditions. In general, enzymatic nucleic acids act by first binding to a target RNA. Such binding occurs through the target binding portion of a enzymatic nucleic acid which is held in close proximity to an enzymatic portion of the molecule that acts to cleave the target RNA. Thus, the enzymatic nucleic acid first recognizes and then binds a target RNA through complementary base pairing, and once bound to the correct site, acts enzymatically to cut the target RNA. Strategic cleavage of such a target RNA will destroy its ability to direct synthesis of an encoded protein. After an enzymatic nucleic acid has bound and cleaved its RNA target, it is released from that RNA to search for another target and can repeatedly bind and cleave new targets.

The enzymatic nature of a ribozyme is advantageous over many technologies, such as antisense technology (where a nucleic acid molecule simply binds to a nucleic acid target to block its translation) since the concentration of ribozyme necessary to affect a therapeutic treatment is lower than that of an antisense oligonucleotide. This advantage reflects the ability of the ribozyme to act enzymatically. Thus, a single ribozyme molecule is able to cleave many molecules of target RNA. In addition, the ribozyme is a highly specific inhibitor, with the specificity of inhibition depending not only on the base pairing mechanism of binding to the target RNA, but also on the mechanism of target RNA cleavage. Single mismatches, or base-substitutions, near the site of cleavage can completely eliminate catalytic activity of a ribozyme. Similar mismatches in antisense molecules do not prevent their action (Woolf et al., 1992). Thus, the specificity of action of a ribozyme is greater than that of an antisense oligonucleotide binding the same RNA site.

The enzymatic nucleic acid molecule may be formed in a hammerhead, hairpin, a hepatitis Δ virus, group I intron or RNaseP RNA (in association with an RNA guide sequence) or Neurospora VS RNA motif. Examples of hammerhead motifs are described by Rossi et al. (1992). Examples of hairpin motifs are described by Hampel et al. (Eur. Pat. Appl. Publ. No. EP 0360257), Hampel and Tritz (1989), Hampel et al. (1990) and U.S. Pat. No. 5,631,359 (specifically incorporated herein by reference). An example of the hepatitis Δ virus motif is described by Perrotta and Been (1992); an example of the RNaseP motif is described by Guerrier-Takada et al. (1983); Neurospora VS RNA ribozyme motif is described by Collins (Saville and Collins, 1990; Saville and Collins, 1991; Collins and Olive, 1993); and an example of the Group I intron is described in U.S. Pat. No. 4,987,071 (specifically incorporated herein by reference).

It can be important to produce enzymatic cleaving agents that exhibit a high degree of specificity for the RNA of a desired target. The enzymatic nucleic acid molecule is preferably targeted to a highly conserved sequence region of a target mRNA. Such enzymatic nucleic acid molecules can be delivered exogenously to specific cells as required, or can be expressed from DNA or RNA vectors that are delivered to specific cells.

Small enzymatic nucleic acid motifs (e.g., of the hammerhead or the hairpin structure) can also be used for exogenous delivery. The simple structure of these molecules increases the ability of the enzymatic nucleic acid to invade targeted regions of the mRNA structure. Alternatively, catalytic RNA molecules can be expressed within cells from eukaryotic promoters (e.g., Scanlon et al., 1991; Kashani-Sabet et al., 1992; Dropulic et al., 1992; Weerasinghe et al., 1991; Ojwang et al., 1992; Chen et al., 1992; Sarver et al., 1990). Those skilled in the art realize that any ribozyme can be expressed in eukaryotic cells from the appropriate DNA vector. The activity of such ribozymes can be augmented by their release from the primary transcript by a second ribozyme (Int. Pat. Appl. Publ. No. WO 93/23569, and Int. Pat. Appl. Publ. No. WO 94/02595, both hereby incorporated by reference; Ohkawa et al., 1992; Taira et al., 1991; and Ventura et al., 1993).

Ribozymes may be added directly, or can be complexed with cationic lipids, lipid complexes, packaged within liposomes, or otherwise delivered to target cells. The RNA or RNA complexes can be locally administered to relevant tissues ex vivo, or in vivo through injection, aerosol inhalation, infusion pump or stent, with or without their incorporation in biopolymers.

Ribozymes may be designed as described in int. Pat. Appl. Publ. No. WO 93/23569 and Int. Pat. Appl. Publ. No. WO 94/02595 (each specifically incorporated herein by reference) and synthesized to be tested in vitro and in vivo, as described. Such ribozymes can also be optimized for delivery. While specific examples are provided, those in the art will recognize that equivalent RNA targets in other species can be utilized when necessary.

Ribozymes of the hammerhead or hairpin motif may be designed to anneal to various sites in the mRNA message, and can be chemically synthesized. The method of synthesis used follows the procedure for normal RNA synthesis as described in Usman et al. (1987) and in Scaringe et al. (1990) and makes use of common nucleic acid protecting and coupling groups, such as dimethoxytrityl at the 5′-end, and phosphoramidites at the 3′-end. Average stepwise coupling yields are typically >98%. Hairpin ribozymes may be synthesized in two parts and annealed to reconstruct an active ribozyme (Chowrira and Burke, 1992). Ribozymes may be modified extensively to enhance stability by modification with nuclease resistant groups, for example, 2′-amino, 2′-C-allyl, T-flouro, 2′-o-methyl, 2′-H (for a review see e.g., Usman and Cedergren, 1992). Ribozymes may be purified by gel electrophoresis using general methods or by high-pressure liquid chromatography and resuspended in water.

Ribozyme activity can be optimized by altering the length of the ribozyme binding arms, or chemically synthesizing ribozymes with modifications that prevent their degradation by serum ribonucleases (see e.g., Int. Pat. Appl. Publ. No. WO 92/07065; Perrault et al, 1990; Pieken et al., 1991; Usman and Cedergren, 1992; Int. Pat. Appl. Publ. No. WO 93/15187; Int. Pat. Appl. Publ. No. WO 91/03162; Eur. Pat. Appl. Publ. No. 92110298.4; U.S. Pat. No. 5,334,711; and Int. Pat. Appl. Publ. No. WO 94/13688, which describe various chemical modifications that can be made to the sugar moieties of enzymatic RNA molecules), modifications which enhance their efficacy in cells, and removal of stem II bases to shorten RNA synthesis times and reduce chemical requirements.

A means of accumulating high concentrations of a ribozyme(s) within cells is to incorporate the ribozyme-encoding sequences into a DNA expression vector. Transcription of the ribozyme sequences are driven from a promoter for eukaryotic RNA polymerase I (pol I), RNA polymerase II (pol II), or RNA polymerase III (pol III). Transcripts from pol II or pol III promoters will be expressed at high levels in all cells; the levels of a given pol II promoter in a given cell type will depend on the nature of the gene regulatory sequences (enhancers, silencers, etc.) present nearby. Prokaryotic RNA polymerase promoters may also be used, providing that the prokaryotic RNA polymerase enzyme is expressed in the appropriate cells (Elroy-Stein and Moss, 1990; Gao and Huang, 1993; Lieber et al., 1993; Zhou et al, 1990). Ribozymes expressed from such promoters can function in mammalian cells (Kashani-Sabet et al, 1992; Ojwang et al, 1992; Chen et at, 1992; Yu et al., 1993; L'Huillier et al., 1992; Lisziewicz et al, 1993). Although incorporation of the present ribozyme constructs into adeno-associated viral vectors is preferred, such transcription units can be incorporated into a variety of vectors for introduction into mammalian cells, including but not restricted to, plasmid DNA vectors, other viral DNA vectors (such as adenovirus vectors), or viral RNA vectors (such as retroviral, semliki forest virus, sindbis virus vectors).

Sullivan et al. (Int. Pat. Appl. Publ. No. WO 94/02595) describes general methods for delivery of enzymatic RNA molecules. Ribozymes may be administered to cells by a variety of methods known to those familiar to the art, including, but not restricted to, encapsulation in liposomes, by iontophoresis, or by incorporation into other vehicles, such as hydrogels, cyclodextrins, biodegradable nanocapsules, and bioadhesive microspheres. For some indications, ribozymes may be directly delivered ex vivo to cells or tissues with or without the aforementioned vehicles. Alternatively, the RNA/vehicle combination may be locally delivered by direct inhalation, by direct injection or by use of a catheter, infusion pump or stent. Other routes of delivery include, but are not limited to, intravascular, intramuscular, subcutaneous or joint injection, aerosol inhalation, oral (tablet or pill form), topical, systemic, ocular, intraperitoneal and/or intrathecal delivery. More detailed descriptions of ribozyme delivery and administration are provided in Int. Pat. Appl. Publ. No. WO 94/02595 and Int. Pat. Appl. Publ. No. WO 93/23569, each specifically incorporated herein by reference.

Ribozymes as disclosed herein can be used to inhibit gene expression and define the role (essentially) of specified gene products in the progression of disease. In this manner, other genetic targets may be defined as important mediators of the disease. These studies lead to better treatment of the disease progression by affording the possibility of combination therapies (e.g., multiple ribozymes targeted to different genes, ribozymes coupled with known small molecule inhibitors, or intermittent treatment with combinations of ribozymes and/or other chemical or biological molecules).

The allosteric ribozymes disclosed herein can have a catalytic activity, such as a phophoesterase activity or an activity such as a peptidyl-transferase activity (Zhang B, Cech T R. Peptidyl-transferase ribozyme: trans reactions, structural characterization and ribosomal RNA-like features. Chem Biol. 1998 October; 5(10):539-53.), ester transferase activity (Jenne A, Famulok M. A novel ribozyme with ester transferase activity. Chem Biol. 1998 January; 5(1);23-34.), amide synthase activity (Wiegand T W, Janssen R C, Eaton B E. Selection of RNA amide synthases. Chem Biol. 1997 September; 4(9):675-83.), carbon-carbon bond formation activity such as a Diels-Alderase activity (Tarasowv T M, Tarasow S L, Eaton B E. RNA-catalysed carbon-carbon bond formation. Nature. 1997 Sep. 4; 389(6646):54-7.), an amino acid transferase activity (Lohse P A, Szostak J W. Ribozyme-catalysed amino-acid transfer reactions. Nature, 1996 May 30; 381(6581):442-4.), an amidase activity (Dai X, De Mesmaeker A, Joyce G F Cleavage of an amide bond by a ribozyme. Science. 1995 Jan. 13; 267(5195):237-40.), a catalytic activity for carrying out the Michael reaction (Sengle G, Eisenfuhr A, Arora P S, Nowick J S, Famulok M. Novel RNA catalysts for the Michael reaction. Chem Biol. 2001 May; 8(5):459-73.). Further catalytic activities shown by the ribozyme moiety of the allosteric ribozymes is cleavage of carboxylic amides and esters. Another catalytic activity which the allosteric ribozymes and polynucleotides may exhibit is a ligase activity which as such is described in Robertson M P, Ellington A D. In vitro selection of nucleoprotein enzymes. Nat Biotechnol. 2001 July. 19(7):650-5; and Robertson M P, Ellington A D. Design and optimization of effector-activated ribozyme ligases. Nucleic Acids Res. 2000 Apr. 15:28(8):1751-9.

### B. Ribozyme Structure

Ligand-binding domains, or aptamers (Gold 1995; Osborne 1997) of ribozymes can be used independently (Hamaguchi 2001; McCauley 2003; Bock 2004) or can be joined with other functional RNA domains (Soukup 2000; Silverman 2003; Soukup 1999) to serve as molecular reporter systems that selectively bind targets and signal their presence to the user. For example, aptamers have been coupled to catalytic RNA domains to form allosteric ribozymes whose activities in many cases are modulated by several orders of magnitude upon effector binding (Soukup 2000). One of skill in the art can generate ribozymes that are coupled to catalytic domains, and would be able to identify those compounds that can be used to trigger the catalytic domain.

The ribozymes disclosed herein can have single or multiple aptamer domains. Aptamer domains in ribozymes having multiple aptamer domains can exhibit cooperative binding of effector molecules or can not exhibit cooperative binding of effector molecules (that is, the aptamers need not exhibit cooperative binding). In the latter case, the aptamer domains can be said to be independent binders. Ribozymes having multiple aptamers can have one or more of the aptamers joined via a linker. Where such aptamers exhibit cooperative binding of effector molecules, the linker can be a cooperative linker.

Aptamer domains can be said to exhibit cooperative binding if they have a Hill coefficient n between x and x−1, where x is the number of aptamer domains (or the number of binding sites on the aptamer domains) that are being analyzed for cooperative binding. Thus, for example, a ribozyme having two aptamer domains can be said to exhibit cooperative binding if the riboswitch has Hill coefficient between 2 and 1. It should be understood that the value of x used depends on the number of aptamer domains being analyzed for cooperative binding, not necessarily the number of aptamer domains present in the ribozyme. This makes sense because a ribozyme can have multiple aptamer domains where only some exhibit cooperative binding.

In addition to the computational methods disclosed herein, also disclosed producing ribozymes using in vitro selection and evolution techniques. In general, in vitro evolution techniques as applied to ribozymes involve producing a set of variant ribozymes where part(s) of the ribozyme sequence is varied while other parts of the ribozyme are held constant. Activation, deactivation or blocking (or other functional or structural criteria) of the set of variant ribozymes can then be assessed and those variant ribozymes meeting the criteria of interest are selected for use or further rounds of evolution. Useful base ribozymes for generation of variants are the specific and consensus ribozymes disclosed herein. Consensus ribozymes can be used to inform which part(s) of a ribozyme to vary for in vitro selection and evolution.

As another example, a transcription terminator can be added to an RNA molecule (most conveniently in an untranslated region of the RNA) where part of the sequence of the transcription terminator is complementary to the control strand of an aptamer domain (the sequence will be the regulated strand). This will allow the control sequence of the aptamer domain to form alternative stem structures with the aptamer strand and the regulated strand, thus either forming or disrupting a transcription terminator stem upon activation or deactivation of the ribozyme. Any other expression element can be brought under the control of a ribozyme by similar design of alternative stem structures.

### C. Designing Ribozymes

Described herein is a computational approach for designing allosteric ribozymes triggered by binding oligonucleotides. Four universal types of RNA switches possessing AND, OR, YES and NOT Boolean logic functions were created in modular form, which allows ligand specificity to be changed without altering the catalytic core of the ribozyme. All computationally designed allosteric ribozymes were synthesized and experimentally tested in vitro (Example 1). Engineered ribozymes exhibit >1,000-fold activation, demonstrate precise ligand specificity and function in molecular circuits in which the self-cleavage product of one RNA triggers the action of a second. This engineering approach provides a rapid and inexpensive way to create allosteric RNAs for constructing complex molecular circuits, nucleic acid detection systems and gene control elements.

Thus, use of the algorithm in methods and computer systems implementing such methods can offer an improvement in predicting potential ribozymes; and predicting RNA secondary structure of such ribozymes. The methods disclosed herein can also be useful in designing ribozymes that are specific to a given effector molecule, such that the ribozyme interacts with the effector molecule in a desired way. A computer system, such as a general purpose computer, which may include a processor, may be used for executing a number of system interface and statistical analysis instructions (e.g., software applications), which may include an embodiment of the algorithm of the present invention. The system may further include an interface for receiving sequence information (from, say, a memory device storing fragments for sampling, user input, a sequencing apparatus, and the like) and outputting structural information, programming interface for programming new models (e.g., targeting criteria) and functionality, and the like. The system can also be part of any integrated system for secondary structure and/or effector accessibility prediction.

Disclosed herein is a method for designing a nucleic acid switch, the method comprising a) generating a random oligonucleotide binding sequence; b) generating a potential nucleic acid switch for molecular computing, wherein the potential nucleic acid switch comprises core sequences and the oligonucleotide binding sequence, wherein a nucleic acid consisting of the core sequences can form a predetermined active structure; c) utilizing an algorithm to predict secondary structure of the potential nucleic acid switch; d) determining if a predetermined portion of the core sequences forms a predetermined structure in the predicted secondary structure of step (c); e) if the predetermined structure of step (d) is formed, then utilizing an algorithm to predict secondary structure of the potential nucleic acid switch with the oligonucelotide binding sequences replaced with nucleotides defined to have no binding properties, otherwise, repeating steps (a) through (e); f) determining if the predicted secondary structure comprises a predetermined active structure; g) if the predetermined active structure of step (f) is formed, then generating a new potential nucleic acid switch comprising the same core sequences and a new random oligonucleotide binding sequence, wherein the new potential nucleic acid switch forms a similar predicted secondary as the predicted secondary structure of step (c) otherwise, repeating steps (a) through (g); h) determining if a predetermined portion of the core sequences forms a predetermined structure in the predicted secondary structure of step (c); i) if the predetermined structure of step (h) is formed, then computing the thermodynamic stability of the predicted secondary structure of step (h), otherwise, repeating steps (a) through (i); j) if the thermodynamic stability of step (i) differs by more than a threshold value from the thermodynamic stability of the predicted secondary structure of step (c), repeat steps (a) through (j); k) computing the thermodynamic stability of the oligonucleotide binding sequence of step (g) when bound to a perfectly matched complementary RNA; 1.) if the thermodynamic stability of step (k) differs by more than a threshold value from the thermodynamic stability of the oligonucleotide binding sequence of step (a) when bound to a perfectly matched complementary RNA, repeat steps (a) through (l); and m) producing a nucleic acid switch comprising the sequence of the new potential nucleic acid switch of step (g).

Disclosed herein is a method of designing a ribozyme, comprising generating an RNA library of potential ribozymes for molecular computing; utilizing an algorithm to predict secondary structure of the potential ribozymes in the presence and absence of a target ligand; determining the difference in the secondary structure of the RNA in the presence and the absence of the target ligand; comparing the difference in the secondary structure in the presence and absence of the target ligand to a set of criteria; and selecting those potential ribozymes which meet the set of criteria; thereby designing a ribozyme.

The RNA library of potential ribozymes can be obtained from a variety of sources. For example, one can start with a known ribozyme, for example a hammerhead ribozyme, and introduce allosteric binding sites into the ribozyme. The allosteric binding site can, for example, alter the ribozyme such that its cleavage activity occurs only in the presence of a predefined oligonucleotide. After that, a number of random sequences residing within the effector binding site(s) (i.e., target ligand binding site, or oligonucleotide binding site(OBS)) can be generated in the ribozyme. One can then use a random search algorithm based on the partition function for formation of dominant secondary structures (McCaskill 1990) in the presence and absence of effector molecules (target ligands). For example, one can generate a new random target binding site, from 16 to 22 nucleotides long, over the alphabet of A, U, C, G.

The target ligand can be any different length. In one embodiment, the target ligand length is varied, and the various lengths are used in the algorithm described herein to generate predicted secondary structures. The algorithm, for example, can be a partition function algorithm, as described in McCaskill et al. (1990). Furthermore, thermodynamic search parameters can be used in the algorithm, as described in Example 1, below. RNAfold source code from the Vienna RNA folding package can used in the algorithm can be used, for example. Base-pairing probabilities for the RNA and target ligand can be computed. The target ligand can be an oligonucleotide, for example. As described above, the oligonucleotide can be varied in length, such that the response of the potential ligand in the presence of the oligonucleotide can be calculated.

Four universal types of RNA switches possessing AND, OR, YES and NOT Boolean logic functions were created in modular form, which allows ligand specificity to be changed without altering the catalytic core of the ribozyme. In the “YES” type, the RNA forms a dominant secondary structure in the absence of the target ligand and a different secondary structure in the presence of the target ligand. In the “NOT” type, the RNA forms a dominant secondary structure in the presence of the target ligand and a different secondary structure in the absence of the target ligand. In the “AND” type, the RNA forms a dominant secondary structure in the absence of two distinct target ligands, and a different secondary structure in the presence of both distinct target ligands. In this example, the presence of only one of the distinct target ligands does not cause the RNA to form a different secondary structure. In the “OR” type, the RNA forms a dominant secondary structure in the absence of both of two distinct target ligands, and a different secondary structure in the presence of one or the other target ligands.

The potential ribozyme can have a modular architecture, such that the modular architecture allows the oligonucleotide binding site to be computationally altered. After identifying a potential ribozyme, sequences found in the oligonucleotide binding site of the potential ribozyme can be varied, thereby designing a second library of potential ribozymes.

The algorithm described above can compute one or more possible secondary structures for the RNA molecule. For example, the algorithm can compute the secondary structure of 1, 2, 3, 4, 5, 6, 7, 8, 9, 10, 15, 20, 25, 50, 100, 150, 200, 250, 300, 350, 400, 450, 500, 750, 1000, 2000, 3000, 4000, 5000, 6000, 7000, 8000, 9000, 10,000, 20,000, 50,000, or 100,000 or more different RNA molecules in the absence or the presence of a target ligand. The program RNAinverse (Vienna RNA folding package) can be used. For example, RNAinverse can be used to generate new RNA sequences that possesses similar secondary structure folding to a known ribozyme, but random sequence of the target binding site.

The “set of criteria” disclosed above refers to a comparison of the secondary structure of a potential ribozyme in the presence and the absence of a target ligand. These are also referred to as “active” or “inactive” states of the ribozyme. The active or inactive state refers to whether the ribozyme is in the presence of the target ligand or not. For example, in the “YES” type, the ribozyme is inactive in the absence of the target ligand, and active in the presence of the target ligand. This is also referred to as an “OFF” or “ON” state, again using the example of “YES”, “ON” is in the presence of the target ligand and “OFF” is in the absence of the target ligand. If the “active” and “inactive” states are separated by a large energy barrier (e.g., strong base-pairing interactions must be disrupted to exchange states), then the ribozyme cannot transition easily between the two states without more proactive denaturation and reannealing. In contrast, if the energy barrier between the two states is small, then the ribozyme can exhibit a poor dynamic range for modulation by the effector. This is referred to herein as the “energy gap” (the difference between the energies found in the “OFF” and “ON” states). For example, if the energy gap is below −4, −5, −6, −7, −8, or −9 kcal mol⁻¹, then the potential ribozyme can be rejected, or if the energy gap is above −8, −9, −10, −11, −12, −13, −14, or −15 kcal mol⁻¹, then the potential ribozyme can also be rejected. In one example, I the energy gap is less than −6 kcal mol⁻¹ or greater than −10 kcal mol⁻¹, the potential ribozyme can be rejected. This gap was chosen based on an estimate of the balance between maintaining a stable OFF state and rapidly overcoming this stability via the energy of DNA effector binding.

One can optionally determine the percentage of nucleotides in the target ligand binding site that participate in base-pairing interactions in the absence of the target ligand. One can then decide, based on this value, whether to proceed with that given potential ribozyme. For example, if this value is <30% or >70%, that particular potential ribozyme can be removed from the pool of potential ribozymes. Of course, this value will depend on the type of ribozyme and the number of nucleotides in the target ligand binding site. One of skill in the art is able to determine this value based on the individual ribozyme.

The algorithm can compute the secondary structure under a variety of conditions, for example, the secondary structures can be computed as a function of temperature (Bonhoeffer 1993), which allows the user to choose to build only those constructs that are predicted to exhibit the desired molecular switch characteristics. For example, the temperature can held at 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or more or less (or any amount in between) degrees Celsius. The program RNAheat (Vienna RNA folding package) can be used, for example, to model the secondary structure under various temperatures.

The ensemble diversity for OFF and ON states can also be calculated. In one example, if the ensemble diversity does not exceed 3, 4, 5, 6, 7, 8, 9, 10, 11, 12, 13, 14, 15, 16, 17, or 18 units (higher values indicate greater secondary structure variability) (Penchovsky 2003), the RNA sequence can continue as a potential ribozyme.

The program kinRNA (Flamm 2000) can also be used to determine the usefulness of the potential ribozyme. For example, if the dominant structure is not folded within 400, 420, 440, 460, 480, 500, 520, 540, 560, 580, or 600 units (or any amount larger, smaller, or in between) (larger arbitrary units indicate slower folding), the potential ribozyme can be rejected.

A variety of stages can be used to design the algorithm. For example, one may choose to complete a first stage algorithm with a given structure, then vary the nucleotides comprising the target ligand binding site and run the algorithm again. The various stages can comprise any of the embodiments disclosed herein. For example, if a first ribozyme is identified and then its nucleotide composition (such as in the target binding site) is varied, thereby generating a second generation of potential ribozymes, the thermodynamic stability of the first potential ribozyme can be compared to those of the second generation. In one example, if the thermodynamic stability of the second generation ribozyme differs by more than 1, 2,3, 4, 5, 6, 7, 8, 9, 10, 11, 12, 13, 14, 15, 16, 17, 18, 19, 20, 21, 22, 23, 24, or 25% compared to the first potential ribozyme, then the second generation potential ribozyme can be rejected. In another example, one can compute the free energy of the dominant OFF state secondary structure of a second generation potential ribozyme based on the partition function and determine the gap between the OFF and ON state free energies. If the energy gap is more than 2, 3, 4, 5, or 6 fold, or any amount in between or less or more, different than the first generation potential ribozyme, the ribozyme can be rejected.

It is to be understood that the disclosed method and compositions are not limited to specific synthetic methods, specific analytical techniques, or to particular reagents unless otherwise specified, and, as such, can vary. It is also to be understood that the terminology used herein is for the purpose of describing particular embodiments only and is not intended to be limiting.

### D. Reporter Proteins and Peptides

For assessing activation of a ribozyme, a reporter protein or peptide can be used. The reporter protein or peptide can be encoded by the RNA the expression of which is regulated by the ribozyme. The examples describe the use of some specific reporter proteins. The use of reporter proteins and peptides is well known and can be adapted easily for use with ribozymes. The reporter proteins can be any protein or peptide that can be detected or that produces a detectable signal. Preferably, the presence of the protein or peptide can be detected using standard techniques (e.g., radioimmunoassay, radio-labeling, immunoassay, assay for enzymatic activity, absorbance, fluorescence, luminescence, and Western blot). More preferably, the level of the reporter protein is easily quantifiable using standard techniques even at low levels. Useful reporter proteins include luciferases, green fluorescent proteins and their derivatives, such as firefly luciferase (FL) from Photinus pyralis, and Renilla luciferase (RL) from Renilla reniformis.

### E. Conformation Dependent Labels

Conformation dependent labels refer to all labels that produce a change in fluorescence intensity or wavelength based on a change in the form or conformation of the molecule or compound with which the label is associated. Examples of conformation dependent labels used in the context of probes and primers include molecular beacons, Amplifluors, FRET probes, cleavable FRET probes, TaqMan probes, scorpion primers, fluorescent triplex oligos including but not limited to triplex molecular beacons or triplex FRET probes, fluorescent water-soluble conjugated polymers, PNA probes and QPNA probes. Such labels, and, in particular, the principles of their function, can be adapted for use with ribozymes. Several types of conformation dependent labels are reviewed in Schweitzer and Kingsmore, Curr. Opin. Biotech. 12:21-27 (2001).

Stem quenched labels, a form of conformation dependent labels, are fluorescent labels positioned on a nucleic acid such that when a stem structure forms a quenching moiety is brought into proximity such that fluorescence from the label is quenched. When the stem is disrupted (such as when a ribozyme containing the label is activated), the quenching moiety is no longer in proximity to the fluorescent label and fluorescence increases. Examples of this effect can be found in molecular beacons, fluorescent triplex oligos, triplex molecular beacons, triplex FRET probes, and QPNA probes, the operational principles of which can be adapted for use with ribozymes.

Stem activated labels, a form of conformation dependent labels, are labels or pairs of labels where fluorescence is increased or altered by formation of a stem structure. Stem activated labels can include an acceptor fluorescent label and a donor moiety such that, when the acceptor and donor are in proximity (when the nucleic acid strands containing the labels form a stem structure), fluorescence resonance energy transfer from the donor to the acceptor causes the acceptor to fluoresce. Stem activated labels are typically pairs of labels positioned on nucleic acid molecules (such as ribozmes) such that the acceptor and donor are brought into proximity when a stem structure is formed in the nucleic acid molecule. If the donor moiety of a stem activated label is itself a fluorescent label, it can release energy as fluorescence (typically at a different wavelength than the fluorescence of the acceptor) when not in proximity to an acceptor (that is, when a stem structure is not formed). When the stem structure forms, the overall effect would then be a reduction of donor fluorescence and an increase in acceptor fluorescence. FRET probes are an example of the use of stem activated labels, the operational principles of which can be adapted for use with ribozymes.

### F. Detection Labels

To aid in detection and quantitation of ribozyme activation, deactivation or blocking, or expression of nucleic acids or protein produced upon activation, deactivation or blocking of ribozymes, detection labels can be incorporated into detection probes or detection molecules or directly incorporated into expressed nucleic acids or proteins. As used herein, a detection label is any molecule that can be associated with nucleic acid or protein, directly or indirectly, and which results in a measurable, detectable signal, either directly or indirectly. Many such labels are known to those of skill in the art. Examples of detection labels suitable for use in the disclosed method are radioactive isotopes, fluorescent molecules, phosphorescent molecules, enzymes, antibodies, and ligands.

Examples of suitable fluorescent labels include fluorescein isothiocyanate (FITC), 5,6-carboxymethyl fluorescein, Texas red, nitrobenz-2-oxa-1,3-diazol-4-yl (NBD), coumarin, dansyl chloride, rhodamine, amino-methyl coumarin (AMCA), Eosin, Erythrosin, BODIPY®, Cascade Blue®, Oregon Green®, pyrene, lissamine, xanthenes, acridines, oxazines, phycoerythrin, macrocyclic chelates of lanthanide ions such as quantum dye™, fluorescent energy transfer dyes, such as thiazole orange-ethidium heterodimer, and the cyanine dyes Cy3, Cy3.5, Cy5, Cy5.5 and Cy7. Examples of other specific fluorescent labels include 3-Hydroxypyrene 5,8,10-Tri Sulfonic acid, 5-Hydroxy Tryptamine (5-HT), Acid Fuchsin, Alizarin Complexon, Alizarin Red, Allophycocyanin, Aminocoumarin, Anthroyl Stearate, Astrazon Brilliant Red 4G, Astrazon Orange R, Astrazon Red 6B, Astrazon Yellow 7 GLL, Atabrine, Auramine, Aurophosphine, Aurophosphine G, BAO 9 (Bisaminophenyloxadiazole), BCECF, Berberine Sulphate, Bisbenzamide, Blancophor FFG Solution, Blancophor SV, Bodipy F1, Brilliant Sulphoflavin FF, Calcien Blue, Calcium Green, Calcofluor RW Solution, Calcofluor White, Calcophor White ABT Solution, Calcophor White Standard Solution, Carbostyryl, Cascade Yellow, Catecholamine, Chinacrine, Coriphosphine O, Coumarin-Phalloidin, CY3.1 8, CY5.1 8, CY7, Dans (1-Dimethyl Amino Naphaline 5 Sulphonic Acid), Dansa (Diamino Naphtyl Sulphonic Acid), Dansyl NH-CH3, Diamino Phenyl Oxydiazole (DAO), Dimethylamino-5-Sulphonic acid, Dipyrrometheneboron Difluoride, Diphenyl Brilliant Flavine 7GFF, Dopamine, Erythrosin ITC, Euchrysin, FIF (Formaldehyde Induced Fluorescence), Flazo Orange, Fluo 3, Fluorescamine, Fura-2, Genacryl Brilliant Red B, Genacryl Brilliant Yellow 10GF, Genacryl Pink 3G, Genacryl Yellow 5GF, Gloxalic Acid, Granular Blue, Haematoporphyrin, Indo-1, Intrawhite Cf Liquid, Leucophor PAF, Leucophor SF, Leucophor WS, Lissamine Rhodamine B200 (RD200), Lucifer Yellow CH, Lucifer Yellow VS, Magdala Red, Marina Blue, Maxilon Brilliant Flavin 10 GFF, Maxilon Brilliant Flavin 8 GFF, MPS (Methyl Green Pyronine Stilbene), Mithramycin, NBD Amine, Nitrobenzoxadidole, Noradrenaline, Nuclear Fast Red, Nuclear Yellow, Nylosan Brilliant Flavin E8G, Oxadiazole, Pacific Blue, Pararosaniline (Feulgen), Phorwite AR Solution, Phorwite BKL, Phorwite Rev, Phorwite RPA, Phosphine 3R, Phthalocyanine, Phycoerythrin R, Polyazaindacene Pontochrome Blue Black, Porphyrin, Primuline, Procion Yellow, Pyronine, Pyronine B, Pyrozal Brilliant Flavin 7GF, Quinacrine Mustard, Rhodamine 123, Rhodamine 5 GLD, Rhodamine 6G, Rhodamine B, Rhodamine B 200, Rhodamine B Extra, Rhodamine BB, Rhodamine BG, Rhodamine WT, Serotonin, Sevron Brilliant Red 2B, Sevron Brilliant Red 4G, Sevron Brilliant Red B, Sevron Orange, Sevron Yellow L, SITS (Primuline), SITS (Stilbene Isothiosulphonic acid), Stilbene, Snarf 1, sulpho Rhodamine B Can C, Sulpho Rhodamine G Extra, Tetracycline, Thiazine Red R, Thioflavin S, Thioflavin TCN, Thioflavin 5, Thiolyte, Thiozol Orange, Tinopol CBS, True Blue, Ultralite, Uranine B, Uvitex SFC, Xylene Orange, and XRITC.

Useful fluorescent labels are fluorescein (5-carboxyfluorescein-N-hydroxysuccinimide ester), rhodamine (5,6-tetramethyl rhodamine), and the cyanine dyes Cy3, Cy3.5, Cy5, Cy5.5 and Cy7. The absorption and emission maxima, respectively, for these fluors are: FITC (490 nm; 520 nm), Cy3 (554 nm; 568 nm), Cy3.5 (581 nm; 588 nm), Cy5 (652 nm: 672 nm), Cy5.5 (682 nm; 703 nm) and Cy7 (755 nm; 778 nm), thus allowing their simultaneous detection. Other examples of fluorescein dyes include 6-carboxyfluorescein (6-FAM), 2′,4′,1,4,-tetrachlorofluorescein (TET), 2′,4′,5′,7′,1,4-hexachlorofluorescein (HEX), 2′,7′-dimethoxy-4′,5′-dichloro-6-carboxyrhodamine (JOE), 2′-chloro-5′-fluoro-7′,8′-fused phenyl-1,4-dichloro-6-carboxyfluorescein (NED), and 2′-chloro-7′-phenyl-1,4-dichloro-6-carboxyfluorescein (VIC). Fluorescent labels can be obtained from a variety of commercial sources, including Amersham Pharmacia Biotech, Piscataway, N.J.; Molecular Probes, Eugene, Oreg.; and Research Organics, Cleveland, Ohio.

Additional labels of interest include those that provide for signal only when the probe with which they are associated is specifically bound to a target molecule, where such labels include: “molecular beacons” as described in Tyagi & Kramer, Nature Biotechnology (1996) 14:303 and EP 0 070 685 B1. Other labels of interest include those described in U.S. Pat. No. 5,563,037; WO 97/17471 and WO 97/17076.

Labeled nucleotides are a useful form of detection label for direct incorporation into expressed nucleic acids during synthesis. Examples of detection labels that can be incorporated into nucleic acids include nucleotide analogs such as BrdUrd (5-bromodeoxyuridine, Hoy and Schimke, Mutation Research 290:217-230 (1993)), aminoallyldeoxyuridine (Henegariu et al., Nature Biotechnology 18:345-348 (2000)), 5-methylcytosine (Sano et al., Biochim. Biophys. Acta 951:157-165 (1988)), bromouridine (Wansick et al., J. Cell Biology 122:283-293 (1993)) and nucleotides modified with biotin (Langer et al., Proc. Natl. Acad. Sci. USA 78:6633 (1981)) or with suitable haptens such as digoxygenin (Kerkhof, Anal. Biochem. 205:359-364 (1992)). Suitable fluorescence-labeled nucleotides are Fluorescein-isothiocyanate-dUTP, Cyanine-3-dUTP and Cyanine-5-dUTP (Yu et al., Nucleic Acids Res., 22:3226-3232 (1994)). A preferred nucleotide analog detection label for DNA is BrdUrd (bromodeoxyuridine, BrdUrd, BrdU, BUdR, Sigma-Aldrich Co). Other useful nucleotide analogs for incorporation of detection label into DNA are AA-dUTP (aminoallyl-deoxyuridine triphosphate, Sigma-Aldrich Co.), and 5-methyl-dCTP (Roche Molecular Biochemicals). A useful nucleotide analog for incorporation of detection label into RNA is biotin-16-UTP (biotin-16-uridine-5′-triphosphate, Roche Molecular Biochemicals). Fluorescein, Cy3, and Cy5 can be linked to dUTP for direct labeling. Cy3.5 and Cy7 are available as avidin or anti-digoxygenin conjugates for secondary detection of biotin- or digoxygenin-labeled probes.

Detection labels that are incorporated into nucleic acid, such as biotin, can be subsequently detected using sensitive methods well-known in the art. For example, biotin can be detected using streptavidin-alkaline phosphatase conjugate (Tropix, Inc.), which is bound to the biotin and subsequently detected by chemiluminescence of suitable substrates (for example, chemiluminescent substrate CSPD: disodium, 3-(4-methoxyspiro-[1,2,-dioxetane-3-2′-(5′-chloro)tricyclo [3.3.1.1^{3,7}]decane]-4-yl) phenyl phosphate; Tropix, Inc.). Labels can also be enzymes, such as alkaline phosphatase, soybean peroxidase, horseradish peroxidase and polymerases, that can be detected, for example, with chemical signal amplification or by using a substrate to the enzyme which produces light (for example, a chemiluminescent 1,2-dioxetane substrate) or fluorescent signal.

Molecules that combine two or more of these detection labels are also considered detection labels. Any of the known detection labels can be used with the disclosed probes, tags, molecules and methods to label and detect activated or deactivated ribozymes or nucleic acid or protein produced in the disclosed methods. Methods for detecting and measuring signals generated by detection labels are also known to those of skill in the art. For example, radioactive isotopes can be detected by scintillation counting or direct visualization; fluorescent molecules can be detected with fluorescent spectrophotometers; phosphorescent molecules can be detected with a spectrophotometer or directly visualized with a camera; enzymes can be detected by detection or visualization of the product of a reaction catalyzed by the enzyme; antibodies can be detected by detecting a secondary detection label coupled to the antibody. As used herein, detection molecules are molecules which interact with a compound or composition to be detected and to which one or more detection labels are coupled.

### G. Sequence Similarities

It is understood that as discussed herein the use of the terms homology and identity mean the same thing as similarity. Thus, for example, if the use of the word homology is used between two sequences (non-natural sequences, for example) it is understood that this is not necessarily indicating an evolutionary relationship between these two sequences, but rather is looking at the similarity or relatedness between their nucleic acid sequences. Many of the methods for determining homology between two evolutionarily related molecules are routinely applied to any two or more nucleic acids or proteins for the purpose of measuring sequence similarity regardless of whether they are evolutionarily related or not.

In general, it is understood that one way to define any known variants and derivatives or those that might arise, of the disclosed ribozymes herein, is through defining the variants and derivatives in terms of homology to specific known sequences. This identity of particular sequences disclosed herein is also discussed elsewhere herein. In general, variants of ribozymes disclosed herein disclosed typically have at least, about 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 percent homology to a stated sequence or a native sequence. Those of skill in the art readily understand how to determine the homology of two proteins or nucleic acids, such as genes. For example, the homology can be calculated after aligning the two sequences so that the homology is at its highest level.

Another way of calculating homology can be performed by published algorithms. Optimal alignment of sequences for comparison can be conducted by the local homology algorithm of Smith and Waterman Adv. Appl. Math. 2: 482 (1981), by the homology alignment algorithm of Needleman and Wunsch, J. MoL Biol. 48: 443 (1970), by the search for similarity method of Pearson and Lipman, Proc. Natl. Acad. Sci. U.S.A. 85: 2444 (1988), by computerized implementations of these algorithms (GAP, BESTFIT, FASTA, and TFASTA in the Wisconsin Genetics Software Package, Genetics Computer Group, 575 Science Dr., Madison, Wis.), or by inspection.

The same types of homology can be obtained for nucleic acids by for example the algorithms disclosed in Zuker, M. Science 244:48-52, 1989, Jaeger et al. Proc. Natl. Acad. Sci. USA 86:7706-7710, 1989, Jaeger et al. Methods Enzymol. 183:281-306, 1989 which are herein incorporated by reference for at least material related to nucleic acid alignment. It is understood that any of the methods typically can be used and that in certain instances the results of these various methods can differ, but the skilled artisan understands if identity is found with at least one of these methods, the sequences would be said to have the stated identity.

For example, as used herein, a sequence recited as having a particular percent homology to another sequence refers to sequences that have the recited homology as calculated by any one or more of the calculation methods described above. For example, a first sequence has 80 percent homology, as defined herein, to a second sequence if the first sequence is calculated to have 80 percent homology to the second sequence using the Zuker calculation method even if the first sequence does not have 80 percent homology to the second sequence as calculated by any of the other calculation methods. As another example, a first sequence has 80 percent homology, as defined herein, to a second sequence if the first sequence is calculated to have 80 percent homology to the second sequence using both the Zuker calculation method and the Pearson and Lipman calculation method even if the first sequence does not have 80 percent homology to the second sequence as calculated by the Smith and Waterman calculation method, the Needleman and Wunsch calculation method, the Jaeger calculation methods, or any of the other calculation methods. As yet another example, a first sequence has 80 percent homology, as defined herein, to a second sequence if the first sequence is calculated to have 80 percent homology to the second sequence using each of calculation methods (although, in practice, the different calculation methods will often result in different calculated homology percentages).

### H. Nucleic Acids

There are a variety of molecules disclosed herein that are nucleic acid based, including, for example, ribozymes, aptamers, and nucleic acids that encode proteins disclosed herein. The disclosed nucleic acids can be made up of for example, nucleotides, nucleotide analogs, or nucleotide substitutes. Non-limiting examples of these and other molecules are discussed herein. It is understood that for example, when a vector is expressed in a cell, that the expressed mRNA will typically be made up of A, C, G, and U. Likewise, it is understood that if a nucleic acid molecule is introduced into a cell or cell environment through for example exogenous delivery, it is advantageous that the nucleic acid molecule be made up of nucleotide analogs that reduce the degradation of the nucleic acid molecule in the cellular environment.

So long as their relevant function is maintained, ribozymes, aptamers, catalytic RNA domains and any other oligonucleotides and nucleic acids can be made up of or include modified nucleotides (nucleotide analogs). Many modified nucleotides are known and can be used in oligonucleotides and nucleic acids. A nucleotide analog is a nucleotide which contains some type of modification to either the base, sugar, or phosphate moieties. Modifications to the base moiety would include natural and synthetic modifications of A, C, G, and T/U as well as different purine or pyrimidine bases, such as uracil-5-yl, hypoxanthin-9-yl (I), and 2-aminoadenin-9-yl. A modified base includes but is not limited to 5-methylcytosine (5-me-C), 5-hydroxymethyl cytosine, xanthine, hypoxanthine, 2-aminoadenine, 6-methyl and other alkyl derivatives of adenine and guanine, 2-propyl and other alkyl derivatives of adenine and guanine, 2-thiouracil, 2-thiothymine and 2-thiocytosine, 5-halouracil and cytosine, 5-propynyl uracil and cytosine, 6-azo uracil, cytosine and thymine, 5-uracil (pseudouracil), 4-thiouracil, 8-halo, 8-amino, 8-thiol, 8-thioalkyl, 8-hydroxyl and other 8-substituted adenines and guanines, 5-halo particularly 5-bromo, 5-trifluoromethyl and other 5-substituted uracils and cytosines, 7-methylguanine and 7-methyladenine, 8-azaguanine and 8-azaadenine, 7-deazaguanine and 7-deazaadenine and 3-deazaguanine and 3-deazaadenine. Additional base modifications can be found for example in U.S. Pat. No. 3,687,808, Englisch et al., Angewandte Chemie, International Edition, 1991, 30, 613, and Sanghvi, Y. S., Chapter 15, Antisense Research and Applications, pages 289-302, Crooke, S. T. and Lebleu, B. ed., CRC Press, 1993. Certain nucleotide analogs, such as 5-substituted pyrimidines, 6-azapyrimidines and N-2, N-6 and O-6 substituted purines, including 2-aminopropyladenine, 5-propynyluracil and 5-propynylcytosine. 5-methylcytosine can increase the stability of duplex formation. Other modified bases are those that function as universal bases. Universal bases include 3-nitropyrrole and 5-nitroindole. Universal bases substitute for the normal bases but have no bias in base pairing. That is, universal bases can base pair with any other base. Base modifications often can be combined with for example a sugar modification, such as 2′-O-methoxyethyl, to achieve unique properties such as increased duplex stability. There are numerous United States patents such as U.S. Pat. Nos. 4,845,205; 5,130,302; 5,134,066; 5,175,273; 5,367,066; 5,432,272; 5,457,187; 5,459,255; 5,484,908; 5,502,177; 5,525,711; 5,552,540; 5,587,469; 5,594,121, 5,596,091; 5,614,617; and 5,681,941, which detail and describe a range of base modifications. Each of these patents is herein incorporated by reference in its entirety, and specifically for their description of base modifications, their synthesis, their use, and their incorporation into oligonucleotides and nucleic acids.

Nucleotide analogs can also include modifications of the sugar moiety. Modifications to the sugar moiety would include natural modifications of the ribose and deoxyribose as well as synthetic modifications. Sugar modifications include but are not limited to the following modifications at the 2′ position: OH; F; O-, S-, or N-alkyl; O-, S-, or N-alkenyl; O-, S- or N-alkynyl; or O-alkyl-O-alkyl, wherein the alkyl, alkenyl and alkynyl can be substituted or unsubstituted C1 to C10, alkyl or C2 to C10 alkenyl and alkynyl. 2′ sugar modifications also include but are not limited to —O[(CH₂)ₙO]m CH₃, —O(CH₂)n OCH₃, —O(CH₂)n NH₂, —O(CH₂)n CH₃, —O(CH₂)n —ONH₂, and —O(CH₂)nON[(CH₂)n CH₃)]₂, where n and m are from 1 to about 10.

Other modifications at the 2′ position include but are not limited to: C1 to C10 lower alkyl, substituted lower alkyl, alkaryl, aralkyl, O-alkaryl or O-aralkyl, SH, SCH₃, OCN, Cl, Br, CN, CF₃, OCF₃, SOCH₃, SO₂ CH₃, ONO₂, NO₂, N₃, NH₂, heterocycloalkyl, heterocycloalkaryl, aminoalkylamino, polyalkylamino, substituted silyl, an RNA cleaving group, a reporter group, an intercalator, a group for improving the pharmacokinetic properties of an oligonucleotide, or a group for improving the pharmacodynamic properties of an oligonucleotide, and other substituents having similar properties. Similar modifications can also be made at other positions on the sugar, particularly the 3′ position of the sugar on the 3′ terminal nucleotide or in 2′-5′ linked oligonucleotides and the 5′ position of 5′ terminal nucleotide. Modified sugars would also include those that contain modifications at the bridging ring oxygen, such as CH₂ and S. Nucleotide sugar analogs can also have sugar mimetics such as cyclobutyl moieties in place of the pentofuranosyl sugar. There are numerous United States patents that teach the preparation of such modified sugar structures such as U.S. Pat. Nos. 4,981,957; 5,118,800; 5,319,080; 5,359,044; 5,393,878; 5,446,137; 5,466,786; 5,514,785; 5,519,134; 5,567,811; 5,576,427; 5,591,722; 5,597,909; 5,610,300; 5,627,053; 5,639,873; 5,646,265; 5,658,873; 5,670,633; and 5,700,920, each of which is herein incorporated by reference in its entirety, and specifically for their description of modified sugar structures, their synthesis, their use, and their incorporation into nucleotides, oligonucleotides and nucleic acids.

Nucleotide analogs can also be modified at the phosphate moiety. Modified phosphate moieties include but are not limited to those that can be modified so that the linkage between two nucleotides contains a phosphorothioate, chiral phosphorothioate, phosphorodithioate, phosphotriester, aminoalkylphosphotriester, methyl and other alkyl phosphonates including 3′-alkylene phosphonate and chiral phosphonates, phosphinates, phosphoramidates including 3′-amino phosphoramidate and aminoalkylphosphoramidates, thionophosphoramidates, thionoalkylphosphonates, thionoalkylphosphotriesters, and boranophosphates. It is understood that these phosphate or modified phosphate linkages between two nucleotides can be through a 3′-5′ linkage or a 2′-5′ linkage, and the linkage can contain inverted polarity such as 3′-5′ to 5′-3′ or 2′-5′ to 5′-2′. Various salts, mixed salts and free acid forms are also included. Numerous United States patents teach how to make and use nucleotides containing modified phosphates and include but are not limited to, U.S. Pat. Nos. 3,687,808; 4,469,863; 4,476,301; 5,023,243; 5,177,196; 5,188,897; 5,264,423; 5,276,019; 5,278,302; 5,286,717; 5,321,131; 5,399,676; 5,405,939; 5,453,496; 5,455,233; 5,466,677; 5,476,925; 5,519,126; 5,536,821; 5,541,306; 5,550,111; 5,563,253; 5,571,799; 5,587,361; and 5,625,050, each of which is herein incorporated by reference its entirety, and specifically for their description of modified phosphates, their synthesis, their use, and their incorporation into nucleotides, oligonucleotides and nucleic acids.

It is understood that nucleotide analogs need only contain a single modification, but can also contain multiple modifications within one of the moieties or between different moieties.

Nucleotide substitutes are molecules having similar functional properties to nucleotides, but which do not contain a phosphate moiety, such as peptide nucleic acid (PNA). Nucleotide substitutes are molecules that will recognize and hybridize to (base pair to) complementary nucleic acids in a Watson-Crick or Hoogsteen manner, but which are linked together through a moiety other than a phosphate moiety. Nucleotide substitutes are able to conform to a double helix type structure when interacting with the appropriate target nucleic acid.

Nucleotide substitutes are nucleotides or nucleotide analogs that have had the phosphate moiety and/or sugar moieties replaced. Nucleotide substitutes do not contain a standard phosphorus atom. Substitutes for the phosphate can be for example, short chain alkyl or cycloalkyl internucleoside linkages, mixed heteroatom and alkyl or cycloalkyl internucleoside linkages, or one or more short chain heteroatomic or heterocyclic internucleoside linkages. These include those having morpholino linkages (formed in part from the sugar portion of a nucleoside); siloxane backbones; sulfide, sulfoxide and sulfone backbones; formacetyl and thioformacetyl backbones; methylene formacetyl and thioformacetyl backbones; alkene containing backbones; sulfamate backbones; methyleneimino and methylenehydrazino backbones; sulfonate and sulfonamide backbones; amide backbones; and others having mixed N, O, S and CH2 component parts. Numerous United States patents disclose how to make and use these types of phosphate replacements and include but are not limited to U.S. Pat. Nos. 5,034,506; 5,166,315; 5,185,444; 5,214,134; 5,216,141; 5,235,033; 5,264,562; 5,264,564; 5,405,938; 5,434,257; 5,466,677; 5,470,967; 5,489,677; 5,541,307; 5,561,225; 5,596,086; 5,602,240; 5,610,289; 5,602,240; 5,608,046; 5,610,289; 5,618,704; 5,623,070; 5,663,312; 5,633,360; 5,677,437; and 5,677,439, each of which is herein incorporated by reference its entirety, and specifically for their description of phosphate replacements, their synthesis, their use, and their incorporation into nucleotides, oligonucleotides and nucleic acids.

It is also understood in a nucleotide substitute that both the sugar and the phosphate moieties of the nucleotide can be replaced, by for example an amide type linkage (aminoethylglycine) (PNA). U.S. Pat. Nos. 5,539,082; 5,714,331; and 5,719,262 teach how to make and use PNA molecules, each of which is herein incorporated by reference. (See also Nielsen et al., Science 254:1497-1500 (1991)).

Oligonucleotides and nucleic acids can be comprised of nucleotides and can be made up of different types of nucleotides or the same type of nucleotides. For example, one or more of the nucleotides in an oligonucleotide can be ribonucleotides, 2′-O-methyl ribonucleotides, or a mixture of ribonucleotides and 2′-O-methyl ribonucleotides; about 10% to about 50% of the nucleotides can be ribonucleotides, 2′-O-methyl ribonucleotides, or a mixture of ribonucleotides and 2′-O-methyl ribonucleotides; about 50% or more of the nucleotides can be ribonucleotides, 2′-O-methyl ribonucleotides, or a mixture of ribonucleotides and 2′-O-methyl ribonucleotides; or all of the nucleotides are ribonucleotides, 2′-O-methyl ribonucleotides, or a mixture of ribonucleotides and 2′-O-methyl ribonucleotides. Such oligonucleotides and nucleic acids can be referred to as chimeric oligonucleotides and chimeric nucleic acids.

### I. Solid Supports

Solid supports are solid-state substrates or supports with which molecules (such as effector molecules) and ribozymes (or other components used in, or produced by, the disclosed methods) can be associated. Ribozymes and other molecules can be associated with solid supports directly or indirectly. For example, analytes (e.g., effector molecules, target ligands) can be bound to the surface of a solid support or associated with capture agents (e.g., compounds or molecules that bind an analyte) immobilized on solid supports. As another example, ribozymes can be bound to the surface of a solid support or associated with probes immobilized on solid supports. An array is a solid support to which multiple ribozymes, probes or other molecules have been associated in an array, grid, or other organized pattern.

Solid-state substrates for use in solid supports can include any solid material with which components can be associated, directly or indirectly. This includes materials such as acrylamide, agarose, cellulose, nitrocellulose, glass, gold, polystyrene, polyethylene vinyl acetate, polypropylene, polymethacrylate, polyethylene, polyethylene oxide, polysilicates, polycarbonates, teflon, fluorocarbons, nylon, silicon rubber, polyanhydrides, polyglycolic acid, polylactic acid, polyorthoesters, functionalized silane, polypropylfumerate, collagen, glycosaminoglycans, and polyamino acids. Solid-state substrates can have any useful form including thin film, membrane, bottles, dishes, fibers, woven fibers, shaped polymers, particles, beads, microparticles, or a combination. Solid-state substrates and solid supports can be porous or non-porous. A chip is a rectangular or square small piece of material. Preferred forms for solid-state substrates are thin films, beads, or chips. A useful form for a solid-state substrate is a microtiter dish. In some embodiments, a multiwell glass slide can be employed.

An array can include a plurality of ribozymes, effector molecules, ligands, other molecules, compounds or probes immobilized at identified or predefined locations on the solid support. Each predefined location on the solid support generally has one type of component (that is, all the components at that location are the same). Alternatively, multiple types of components can be immobilized in the same predefined location on a solid support. Each location will have multiple copies of the given components. The spatial separation of different components on the solid support allows separate detection and identification.

Although useful, it is not required that the solid support be a single unit or structure. A set of ribozymes, effector molecules, ligands, other molecules, compounds and/or probes can be distributed over any number of solid supports. For example, at one extreme, each component can be immobilized in a separate reaction tube or container, or on separate beads or microparticles.

Methods for immobilization of oligonucleotides to solid-state substrates are well established. Oligonucleotides, including address probes and detection probes, can be coupled to substrates using established coupling methods. For example, suitable attachment methods are described by Pease et al., Proc. Natl. Acad. Sci. USA 91(10:5022-5026 (1994), and Khrapko et al., Mol Biol (Mosk) (USSR) 25:718-730 (1991). A method for immobilization of 3′-amine oligonucleotides on casein-coated slides is described by Stimpson et al., Proc. Natl. Acad. Sci. USA 92:6379-6383 (1995). A useful method of attaching oligonucleotides to solid-state substrates is described by Guo et al., Nucleic Acids Res. 22:5456-5465 (1994).

Each of the components immobilized on the solid support can be located in a different predefined region of the solid support. The different locations can be different reaction chambers. Each of the different predefined regions can be physically separated from each other of the different regions. The distance between the different predefined regions of the solid support can be either fixed or variable. For example, in an array, each of the components can be arranged at fixed distances from each other, while components associated with beads will not be in a fixed spatial relationship. In particular, the use of multiple solid support units (for example, multiple beads) will result in variable distances.

Components can be associated or immobilized on a solid support at any density. Components can be immobilized to the solid support at a density exceeding 400 different components per cubic centimeter. Arrays of components can have any number of components. For example, an array can have at least 1,000 different components immobilized on the solid support, at least 10,000 different components immobilized on the solid support, at least 100,000 different components immobilized on the solid support, or at least 1,000,000 different components immobilized on the solid support.

### J. Systems

Disclosed are systems useful for performing, or aiding in the performance of, the disclosed method. Systems generally comprise combinations of articles of manufacture such as structures, machines, devices, and the like, and compositions, compounds, materials, and the like. Such combinations that are disclosed or that are apparent from the disclosure are contemplated.

### K. Data Structures and Computer Control

Disclosed are data structures used in, generated by, or generated from, the disclosed method. Data structures generally are any form of data, information, and/or objects collected, organized, stored, and/or embodied in a composition or medium. Ribozyme structures and activation measurements stored in electronic form, such as in RAM or on a storage disk, is a type of data structure.

Also disclosed herein is a computer program embodied on a computer-readable medium for designing a ribozyme, comprising an algorithm to predict secondary structure of an RNA molecule in the presence and absence of a target ligand.

The program can further vary the sequences of the oligonucleotide binding site of the potential ribozyme, for example. Also disclosed is a process embodied in an instruction signal of a computing device for generating a potential ribozyme, comprising an algorithm to predict secondary structure of an RNA molecule in the presence and absence of a target ligand.

The disclosed method, or any part thereof or preparation therefor, can be controlled, managed, or otherwise assisted by computer control. Such computer control can be accomplished by a computer controlled process or method, can use and/or generate data structures, and can use a computer program. Such computer control, computer controlled processes, data structures, and computer programs are contemplated and should be understood to be disclosed herein.

### EXAMPLES

### A. Example 1: Computational Design and Experimental Validation of Oligonucleotide-Sensing Allosteric Ribozymes

A partition function algorithm (McCaskill 1990) was used to design RNAs that are predicted to form a dominant secondary structure in the absence of an oligonucleotide effector. This folded pattern can be distinct from the secondary structure that dominates in the presence of a matched oligonucleotide effector. The algorithm computes the entire ensemble of possible secondary structures as a function of temperature (Bonhoeffer 1993), which allows the user to choose to build only those constructs that are predicted to exhibit the desired molecular switch characteristics.

This automated design method can be used to generate a large number of allosteric ribozymes with predefined properties within hours by assessing millions of different sequences on a personal computer. The utility of this method is disclosed herein by designing and testing four universal types of molecular switches possessing AND, OR, NOT and YES Boolean logic functions. Each ribozyme construct has a modular architecture, which allows an oligonucleotide binding site (from 16 to 22 nucleotides in length) to be computationally altered, thus maintaining specific and uniform allosteric function.

### 1. Results

i. Architecture and Design of Allosteric Hammerhead Ribozymes

As is observed with allosteric proteins, RNAs with allosteric function undergo alternative folding of their polymeric structure upon effector binding, which modulates of function at a site that is distal from where the effector has bound. In the case of RNA, stable secondary structures can fold on a time scale of microseconds, and these core elements typically control the subsequent formation of tertiary contacts (Russell 2002; Woodson 2002; Sosnick 2003). The energies involved in secondary structure formation typically are much greater than those of tertiary contacts (Flamm 2001). Thus, a substantial amount of the folding energy that establishes RNA conformations can be modeled at the secondary structure level (Flamm 2001).

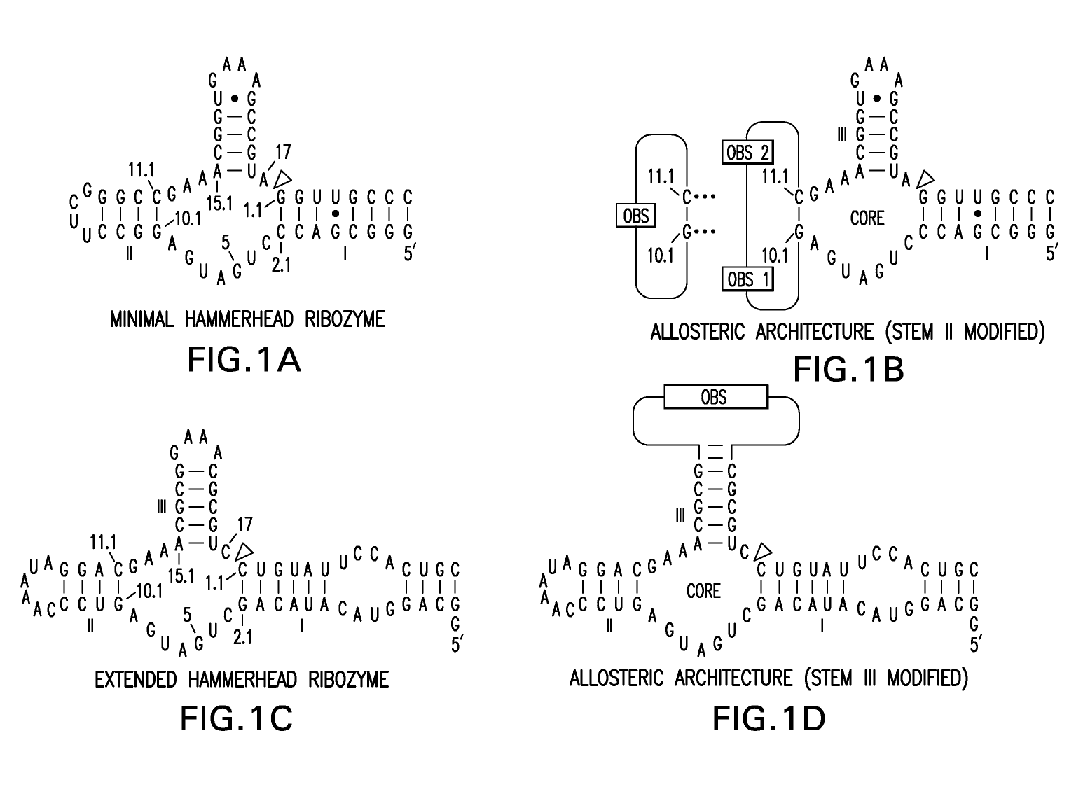

The precise secondary structure required for the hammerhead ribozyme to promote RNA transesterification is well known (FIG. 1 a) (Forster 2001; Hertel 1992). Variations in sequence composition that preclude formation of this essential secondary structure can result in reduced activity, or no activity at all. Allosteric ribozymes can exploit this character of RNA structure by harnessing binding energy involved in effector-RNA complex formation to shift folding patterns or pathways to favor either active or inactive states. If these states are separated by a large energy barrier (e.g., strong base-pairing interactions must be disrupted to exchange states), then the ribozyme cannot transition easily between the two states without more proactive denaturation and reannealing. In contrast, if the energy barrier between the two states is small, then the ribozyme might exhibit a poor dynamic range for modulation by the effector. It is these aspects of allosteric ribozyme design that have previously been most difficult to anticipate and control during the design process.

The architecture of most ribozyme constructs chosen for this study exploit the sequence versatility of nucleotides residing in stem II of the hammerhead ribozyme (FIG. 1b). This same region has been used extensively as the location for grafting aptamers when creating numerous other allosteric ribozyme constructs (Seetharaman 2001; Jose 2001; Soukup 1991; Koizumi 1999). An extended hammerhead construct (FIG. 1c) was used to introduce allosteric binding sites into stem III (FIG. 1d). A two-step computational procedure was applied to design allosteric hammerhead ribozymes that modulate their cleavage activity only in the presence of predefined oligonucleotides. In the first step, a large number of random sequences (˜107) residing within the effector binding site(s) were examined computationally using a random search algorithm based on the partition function for formation of dominant secondary structures (McCaskill 1990) in the presence and absence of effector molecules with different lengths. Nucleotide sequences residing within an oligonucleotide binding site (OBS) must satisfy two criteria for a given construct to be chosen for testing. First, OBS nucleotides must be predicted to participate in forming stable but inactive secondary structure (OFF state) in the absence of an effector oligonucleotide. Second, OBS nucleotides must stably pair with the effector DNA and liberate adjoining nucleotides that are predicted to form a stable stem II structure that allows activation of the ribozyme domain (ON state).

ii. Design and Characterization of Ribozymes with YES Function

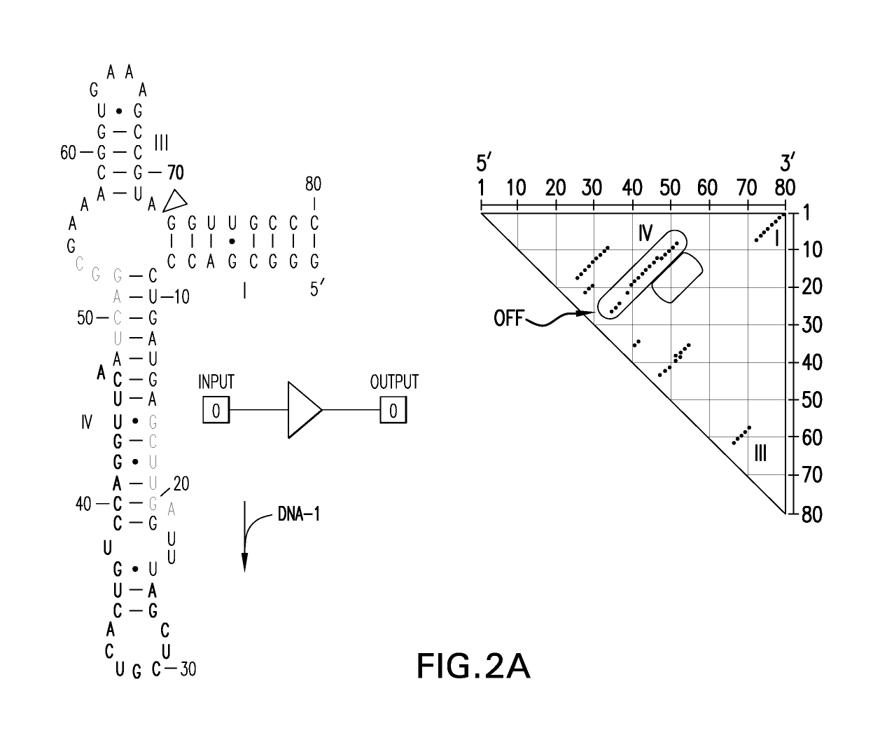

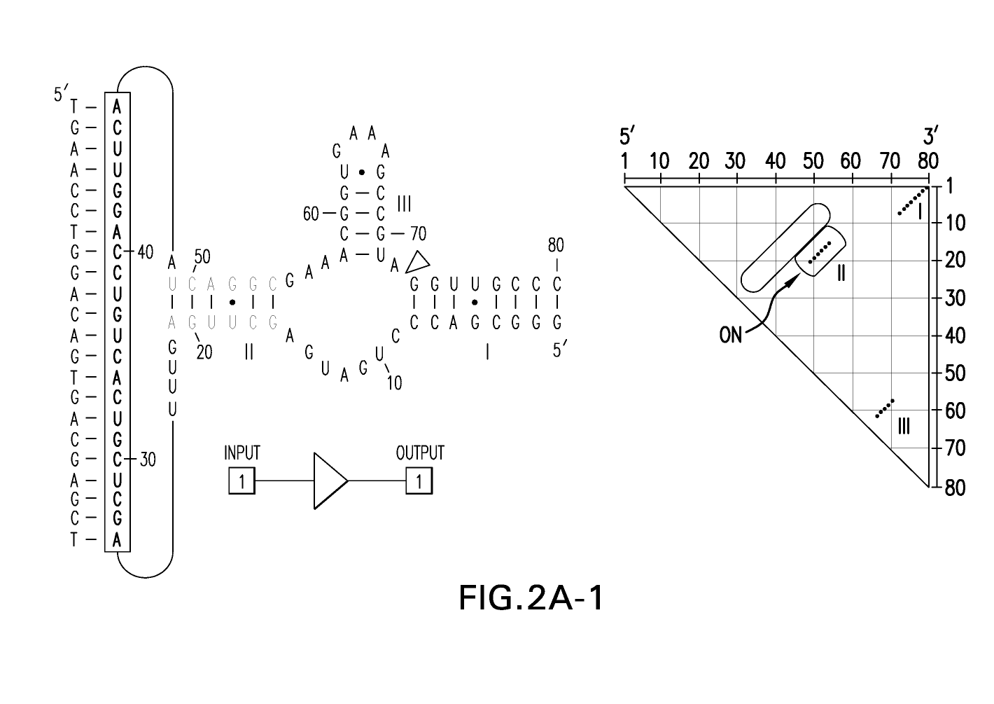

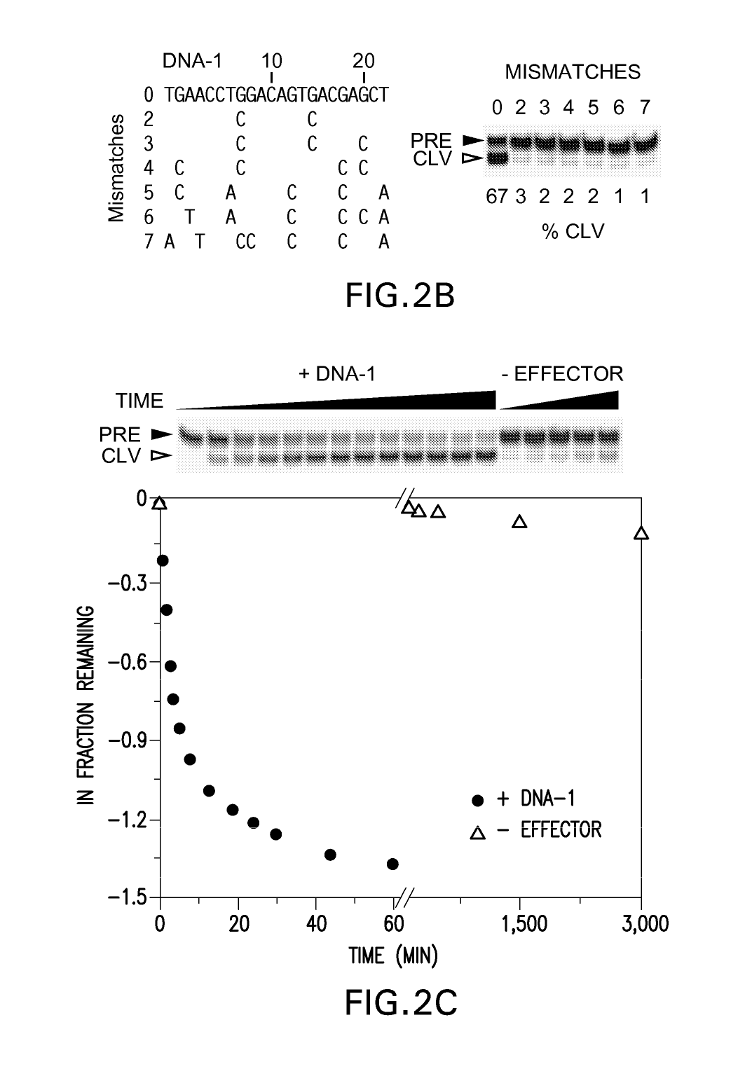

Using the approach described above, a series of five RNA constructs were generated that were predicted to function as RNA switches with molecular YES logic. Molecules with attributes of YES logic function must remain inactive unless receiving a single molecular impulse that triggers activity. One of these constructs, termed YES-1, was predicted to form the desired OFF- and ON-state structures in the absence and presence, respectively, of a 22-nucleotide effector DNA (DNA-1; FIG. 2a). In its inactive conformation, the nucleotides within the OBS are proposed to form a stem IV structure. Stem IV involves extensive base-pairing interactions with portions of the hammerhead core and with most nucleotides that would otherwise form the stem II structure required for ribozyme activation. In the presence of DNA-1, a major portion of the nucleotides in stem IV become sequestered by intermolecular base pairing, and nucleotides that can participate in stem II formation are liberated.

The results of the computational assessment of the structure-forming potential of this construct are visually represented by dot matrix plots (FIG. 2a, right). It is apparent from these plots that the probability of forming stem IV or several base-pairing alternatives is high, whereas there is no indication that stem II has any reasonable chance of forming. In contrast, repeating the computation in the presence of the DNA effector drastically reduces the probability that stem IV can form and thus increases the probability that stem II is formed. It is notable that the probabilities for forming hammerhead stems I and III remain largely unaffected by the presence or absence of the effector DNA. In a subsequent stage of the design procedure, the secondary structure adopted for the YES-1 ribozyme was used as a basis to compute the folding properties of additional allosteric ribozyme candidates that are likely to have very similar RNA energy folding landscapes but that carry different OBS sequences that respond to different effector DNAs.

Five sequences obtained from this computational design process, representing extreme cases in terms of the selection thermodynamics criteria used during computation, were arbitrarily chosen for synthesis and testing. Each RNA construct was prepared by transcription in vitro using radiolabeled nucleotides. The YES-1 RNA construct (FIG. 2a) is representative of ribozyme constructs that were computed to be thermodynamically less stable in their inactive states (free energy based on the partition function at 37° C., Eₚ=−35.6 kcal mol⁻¹) and can form several alternative secondary structures that all preclude formation of stem II.

The performance characteristics of the first RNA, YES-1, was tested by incubation of internally ³²P-labeled RNAs with a matched effector DNA of 22 nucleotides, or with a series of mutant DNAs that carry two through seven mismatches relative to the matched effector DNA (FIG. 2b). Robust self-cleavage was observed only when the perfectly matched effector DNA was present, whereas as few as two mismatches caused complete loss of activation under these assay conditions. From these data, it was concluded that the thermodynamic stability of the OFF state for YES-1 is sufficiently greater than that of the ON state in the absence of effector DNA (Eₚ=−29 kcal mol⁻¹, difference=6.6 kcal mol−1) such that the vast majority of the RNA constructs reside in the inactive conformation during assay incubation.

To estimate the dynamic range for allosteric activation, or the total range of rate constant enhancement brought about by effector binding, a time course for ribozyme self-cleavage was conducted in the presence and absence of the matched effector DNA (FIG. 2c). In the presence of the effector, the apparent rate constant observed for ribozyme activity (apparent k_{obs}) is ˜1.1×10⁻¹ min⁻¹, whereas the apparent k_{obs} for the ribozyme in the absence of effector DNA is ˜1.6×10⁻⁵ min−1. These results indicate that the allosteric dynamic range is nearly 7,000-fold, and the maximum rate constant is within tenfold of the typical maximum activity for the unmodified hammerhead ribozyme core (˜1 min⁻¹) measured under similar conditions (Tang 1997). Furthermore, the stability of the OFF-state structure is not so extreme or so rapidly adopted that activation by the effector DNA is precluded when reaction buffer (FIG. 2b) and DNA are introduced simultaneously to the YES-1 ribozyme.

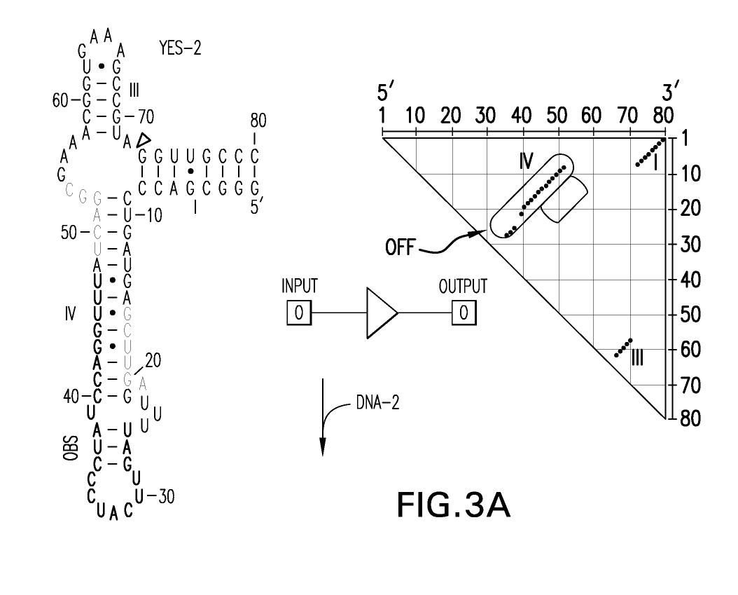

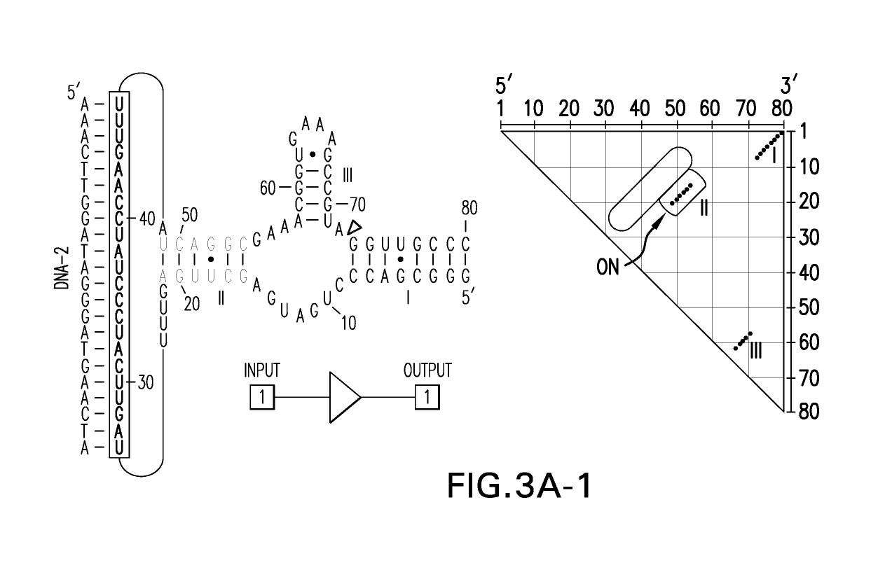

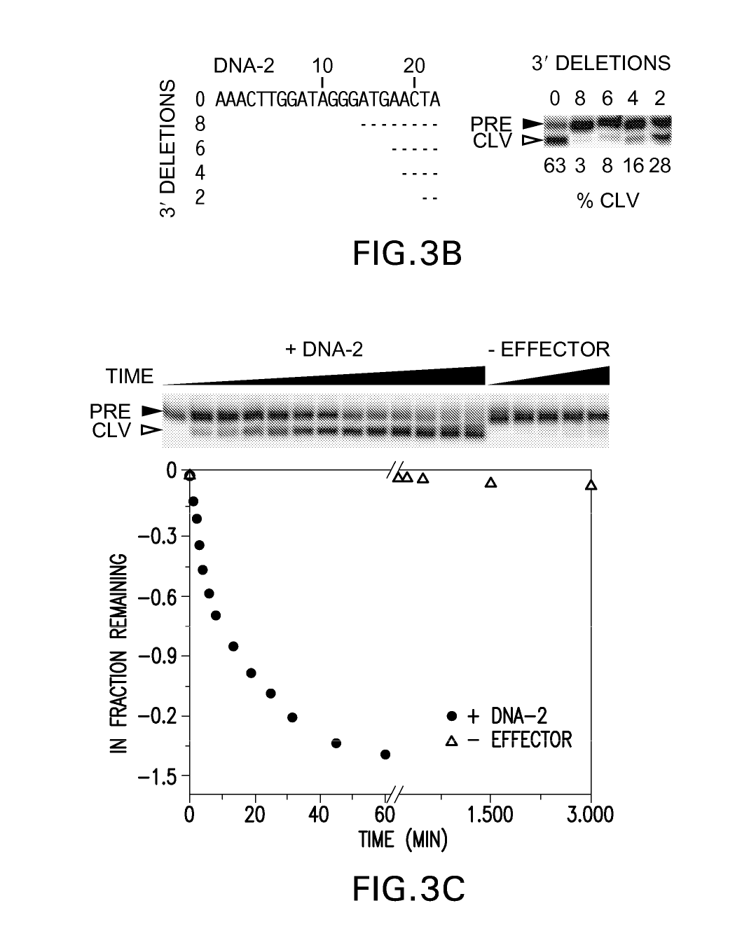

The performance characteristics of a second ribozyme, YES-2 (FIG. 3), were established. YES-2 was selected for testing because it is predicted to be more stable in its

OFF state (Ep=−39 kcal mol⁻¹) than YES-1, although it has a greater difference between the OFF- and ON-states (Ep=−29 kcal mol⁻¹, difference=10 kcal mol⁻¹). This increase in predicted stability for stem IV yields dot matrix plots that show only one OFF-state structure that has a high probability of forming (FIG. 3a), whereas the addition of the effector DNA (DNA-2) that matches the new OBS sequences yields a predicted structure for the ribozyme domain that is identical to that for YES-1.

For this series of experiments, the specificity of effector-mediated activation was tested by using DNAs that differ from the matched YES-1 effector DNA by truncation (FIG. 3b). Although the shortest effector DNA exhibits almost no activation of the YES-2 ribozyme, longer DNAs induce progressively greater yields, with the full-length effector DNA promoting ribozyme cleavage with a yield that is similar to that generated by the YES-1 ribozyme under identical reaction conditions (FIG. 2b).

The apparent k_{obs} values exhibited by the YES-2 ribozyme in the presence and absence of its matched 22-nucleotide effector DNA also were similar to those observed for YES-1 (FIG. 3c), despite the differences in thermodynamic stability and predicted structural heterogeneity between the two constructs. Specifically, the dynamic range for YES-2 is ˜8,000 with apparent k_{obs} values of 1.2×10 ⁵ min⁻¹ and 0.1 min⁻¹ in the absence and presence of DNA-2, respectively. Approximately 25% of YES-2 RNAs remain uncleaved after a 60-minute incubation with the full-length DNA-2 (FIG. 3c), again showing that chemical integrity and/or folding uniformity are not absolute.

Similar molecular switch functions were obtained for the remaining three related constructs (YES-3, YES-4 and YES-5), demonstrating that new RNA switches that respond to distinct DNA effectors can be designed routinely. Furthermore, these constructs function as ‘rapid switches,’ wherein the addition of the matched effector DNA induces activity in an RNA that had been folded into its inactive structure. Alternatively, a construct that was intentionally designed to form an exceptionally stable OFF state structure (YES-6) remains inactive as expected, even upon the introduction of its matched DNA effector. These results indicate that the computational method used to design multistate oligonucleotide-responsive ribozyme structures is robust and has a high probability of accurately predicting allosteric function. With the 22-nucleotide long allosteric binding sites, there are 1.76×10¹³ possible sequence combinations, thus providing an enormous diversity of possible effector specificities. It is predicted that at least 5% of all possible combinations, or nearly a trillion different sequence combinations of 22-nucleotide DNAs, will meet the rigorous criteria used in this study when designing candidate YES gates.

iii. Design and Characterization of a Ribozyme with NOT Function

An extended natural hammerhead ribozyme (FIG. 1c) from Schistosoma mansoni was used as the parent construct for the design of a ribozyme that is deactivated by allosteric interactions with oligonucleotides. This ribozyme exhibits faster RNA cleavage kinetics and requires lower concentrations of Mg2+ to trigger activity (Osborne 2005). Allosteric constructs derived from parental ribozymes with these properties are more likely to function in vivo where divalent ion concentrations are low and where fast ribozymes are needed.

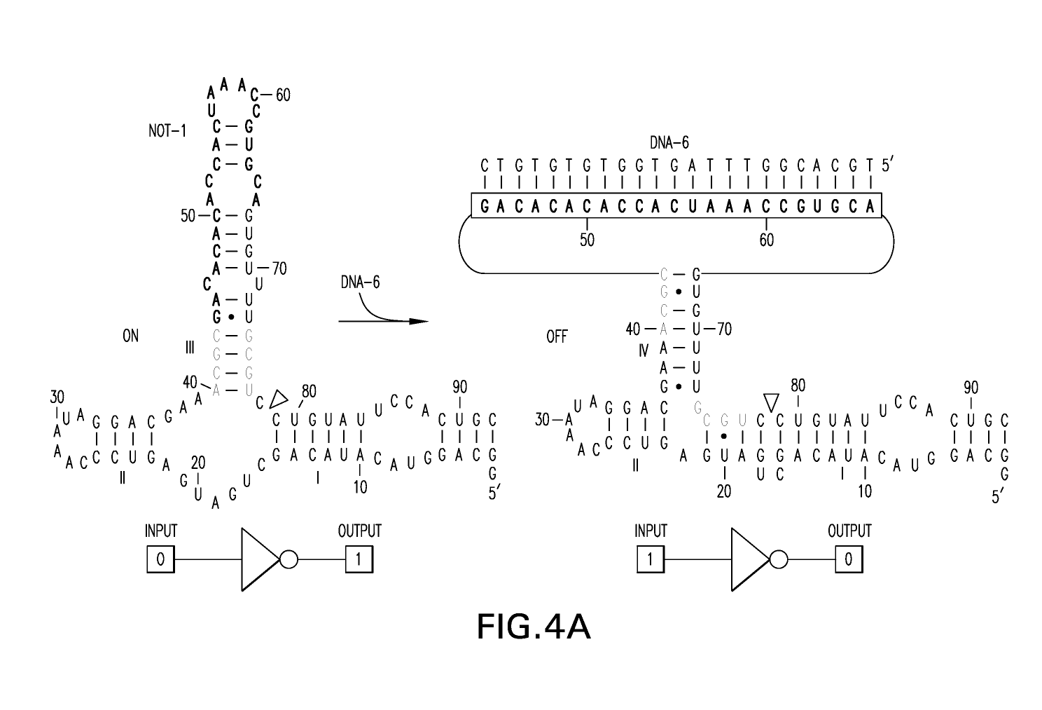

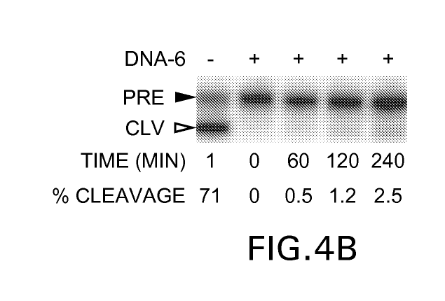

Extended hammerhead ribozymes exhibit improved function because they form a tertiary structure between the loop sequences of stem II and a bulge within stem I (Khvorova 2003; De la Pena 2003; Canny 2004). Therefore, the OBS was relocated to stem III to design a construct that functions as a NOT gate (FIG. 1d) so these critical ribozyme tertiary-structure contacts would not be disrupted. The resulting design, termed NOT-1 (FIG. 4a) can form a single major ON state structure (Ep=−30.55 kcal mol-1) in the absence of effector DNA-6 (23 nucleotides), and can form a single major structure in its effector-bound OFF state that has an extended stem I and a disrupted stem III (Ep=−25.46 kcal mol−1).

If the NOT-1 construct functions as predicted and self-cleaves in the absence of effector DNA, preparation of the RNA is expected to pose a problem because the ribozyme could self-cleave during transcription in vitro. To avoid this, transcription of NOT-1 DNA templates was carried out in the presence of 10 μM DNA-6 and 10 μM of the antisense oligonucleotide CTCATCAGC (SEQ ID NO: 1). The latter DNA is complementary to nucleotides 15 through 23 of the NOT-1 hammerhead core. Although the NOT-1 RNA exhibited 25% self-cleavage when produced by transcription under these conditions, the RNA exhibited robust self-cleavage activity (kobs>1 min−1) when incubated in the absence of DNA-6 (FIG. 4b). Similarly, addition of excess effector oligonucleotide to a NOT-1 ribozyme assay caused strong inhibition.

iv. Design and Characterization of a Ribozyme with AND Function

Molecules with attributes of AND logic function must remain inactive unless receiving two separate molecular impulses that trigger activity. Candidate RNA constructs possessing AND logic function triggered by 16-nucleotide effector DNAs were designed using the same principles and computational procedures used to identify candidate YES RNA switches. However, additional steps were added to permit computation of four different structural states with high stability. As with the YES gate computations, one of the structural states must permit formation of the active hammerhead core, in this case, only when presented with two effector DNA sequences. The remaining three states should not permit ribozyme function even if either of the two effector DNAs are present independently. Computational search efforts indicated that many thousands of ribozymes with the same AND gate properties can be generated.

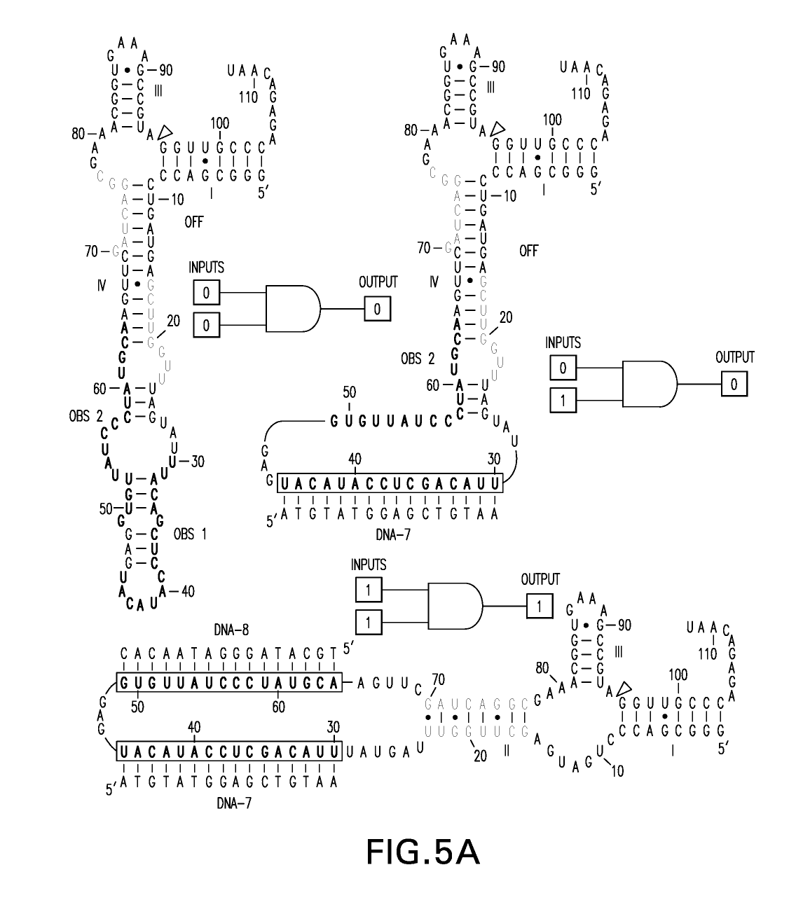

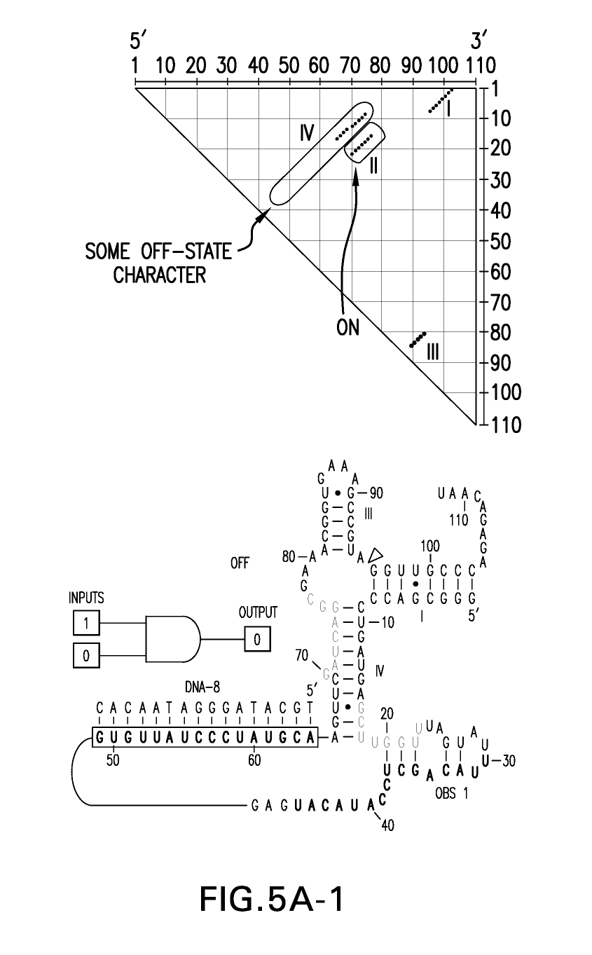

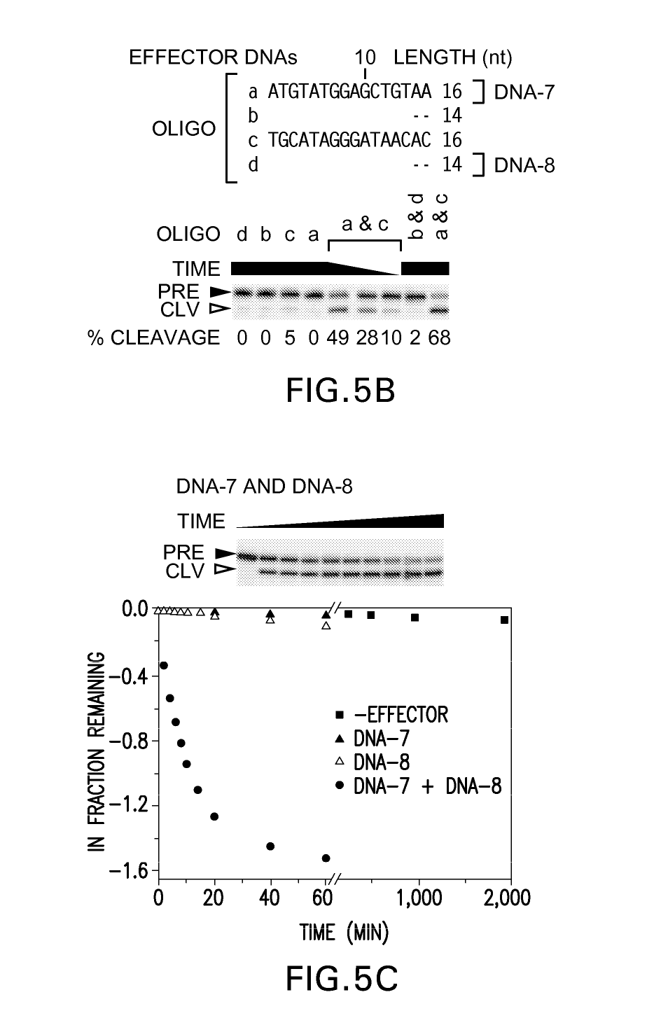

The function of one computationally designed AND gate candidate termed AND-1 was tested. The most probable secondary structure models for all four states of AND-1 and dot matrix plots for the predicted ON state are depicted in FIG. 5a. This RNA construct can have a thermodynamic stability in the absence of effector DNAs (Eₚ=−46.97 kcal mol^{-l}) that is ˜15 kcal mol⁻¹ more stable than the structure representing the active ribozyme state (Eₚ=−31.9 kcal mol⁻¹). The predicted stabilities of the RNA structures are intermediate when either effector DNA-7 (Eₚ=−39.50 kcal mol⁻¹) or effector DNA-8 (Eₚ=−36.30 kcal mol⁻¹) are bound independently. It is notable that, in the presence of both effectors, AND-1 can have approximately equal possibility for formation of stem II and a portion of stem IV, despite the docking of both effector DNAs (FIG. 5a).

The general structural characteristics of AND-1 permit the ribozyme to remain largely inactive in the absence of effector DNAs, or in the presence of either DNA-7 or DNA-8 (FIG. 5b). However, the addition of both effector DNAs triggers robust ribozyme activity. The AND-1 ribozyme also is sensitive to the length of the effector DNAs. Although both 16-nucleotide effector DNAs are needed to trigger AND-1 function, truncation of either DNA by deletion of two nucleotides at their 3′ terminus renders the system inactive, regardless of what combination of full-length and truncated DNAs are used (FIG. 5b).

To confirm these observations, rate constants were experimentally established for all four states with 1 μM AND-1 ribozyme incubated under standard reaction conditions (FIG. 2b legend) without and with 3 μM effector DNAs (FIG. 5c). Again, as computationally predicted, the AND-1 ribozyme exhibited very low self-cleavage activity in the absence of effector DNAs (apparent k_{obs}=2.4×10⁻⁵ min⁻¹), and these poor apparent k_{obs} values persisted when either effector DNA-7 (1×10⁻⁴ min⁻¹) or effector DNA-8 (9×10⁻⁴ min⁻¹) were added independently. In contrast, the addition of both effectors induced an ˜5,000-fold increase in the apparent k_{obs} value (0.11 min⁻¹) relative to that exhibited by AND-1 in the absence of effector DNAs. This maximum apparent k_{obs} value increases to 0.5 min⁻¹ when a single U-to-C change is made at nucleotide 18 (FIG. 5a), which strengthens base pairing in stem II. Given the robust activity of the AND-1 ribozyme and its variant when activated, and given the extent to which these RNAs proceed towards complete processing, it appears that the stem II structure dominates over the stem IV element (FIG. 5a) when presented with both effector DNAs, or at least the two stems are in rapid equilibrium.

v. Design and Characterization of a Ribozyme with OR Function

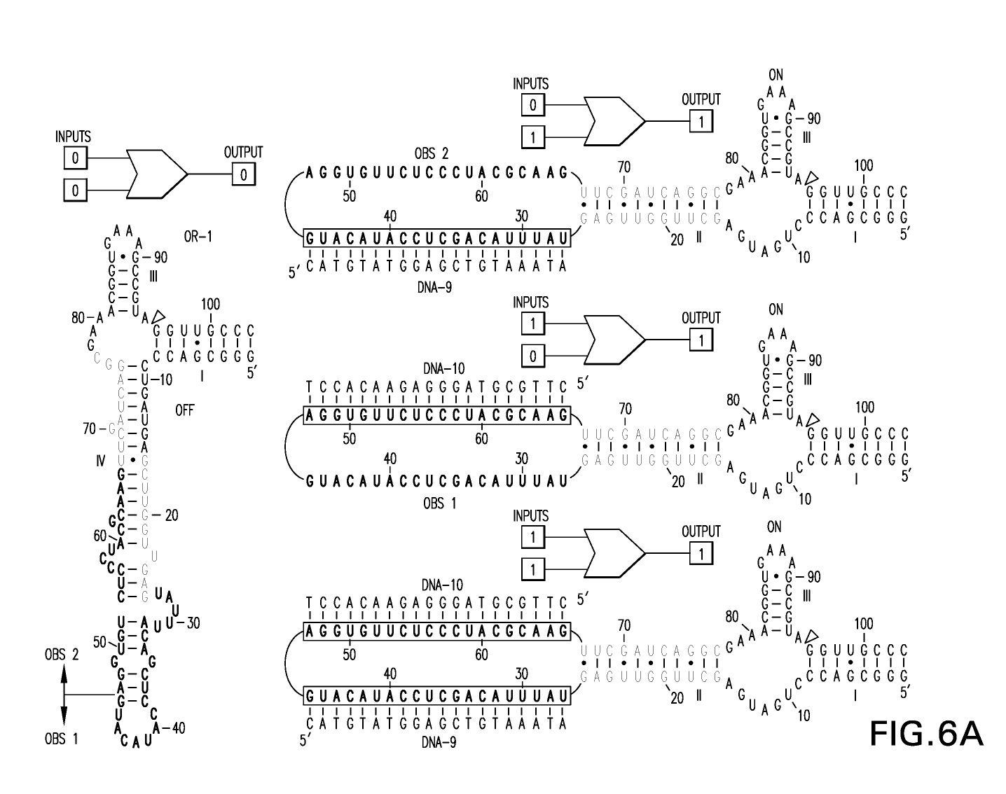

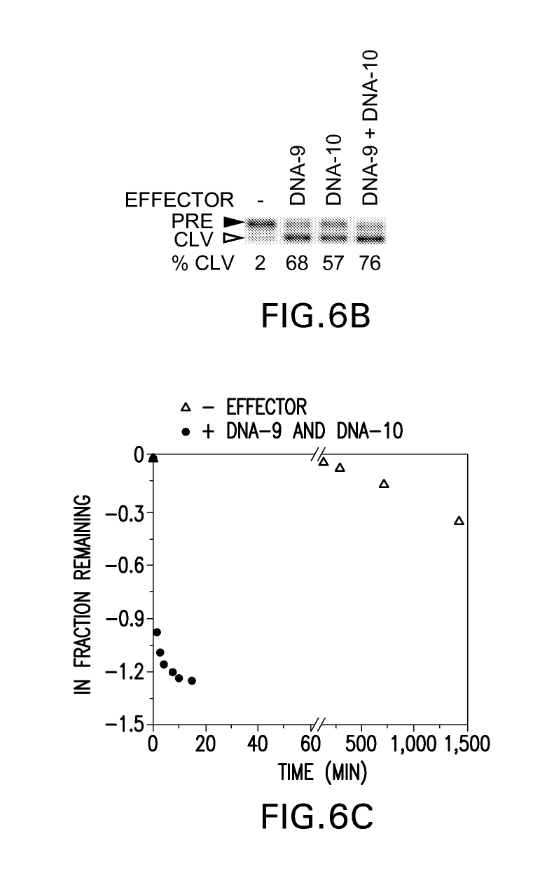

The design of allosteric hammerhead ribozymes possessing OR logic function was conducted in a similar manner to that used to computationally identify AND gate candidates. Again four different states were computed, but in this case the creation of three ON-state structures and only one OFF-state structure was sought. Again, the computational search results indicate that many thousands of ribozymes with OR logic function can be designed. One candidate construct chosen for biochemical analysis, termed OR-1 (FIG. 6a), carries only three nucleotide changes relative to the AND-1 RNA construct depicted in FIG. 5a. As with the other RNA logic gates described above, the most probable OFF state for OR-1 is thermodynamically more stable (Eₚ=−46.5 kcal mol⁻¹) than any of the ON-state structures that permit the formation of stem II (Eₚ=−33.9 kcal mol⁻¹ when both effectors are bound).

The function of OR-1 also was tested for oligonucleotide-induced ribozyme activity. As predicted, OR-1 undergoes little self-cleavage in the absence of effector DNAs, but exhibits robust activity when presented with any combination of effectors DNA-9 and DNA-10, which are 22-mer oligonucleotides that are complementary to OBS sites 1 and 2, respectively (FIG. 6b). Similarly, the allosteric dynamic range for OR-1 was estimated by examining the kinetics of ribozyme cleavage (FIG. 6c) in the absence of effector DNA (apparent k_{obs}=2.3×10⁻⁴ min⁻¹) and in the presence of both DNA-9 and DNA-10 (apparent k_{obs}=0.9 min⁻¹). The dynamic range of this ribozyme is 4,000-fold under standard assay conditions. In an assay mixture that more closely approximates physiological conditions (50 mM Tris-HC1, pH 7.5 at 23 ° C., 100 mM KCl, 25 mM NaCl, and 2 mM MgCl₂) the k_{obs} was found to be about 0.3 min⁻¹ at 37° C. Similar to that observed with AND-1, the k_{obs} value for the OR-1 construct improved to 0.5 min⁻¹ under these assay conditions when position 18 was mutated to a C residue. Moreover, three additional constructs with OR logic function that respond to the same effector DNAs were created, which exhibited properties similar to those of OR-1.

vi. Molecular Circuit Based on RNA Switches with YES Function

An attractive feature of molecular logic gates is the ability to generate signals that can control the activity of other molecular switches. The production of a diversity of oligonucleotide-sensing ribozymes can expand the complexity and efficiency of engineered nucleic acid circuits like those demonstrated previously (Stojanovic 2003a; Stojanovic 2003b).

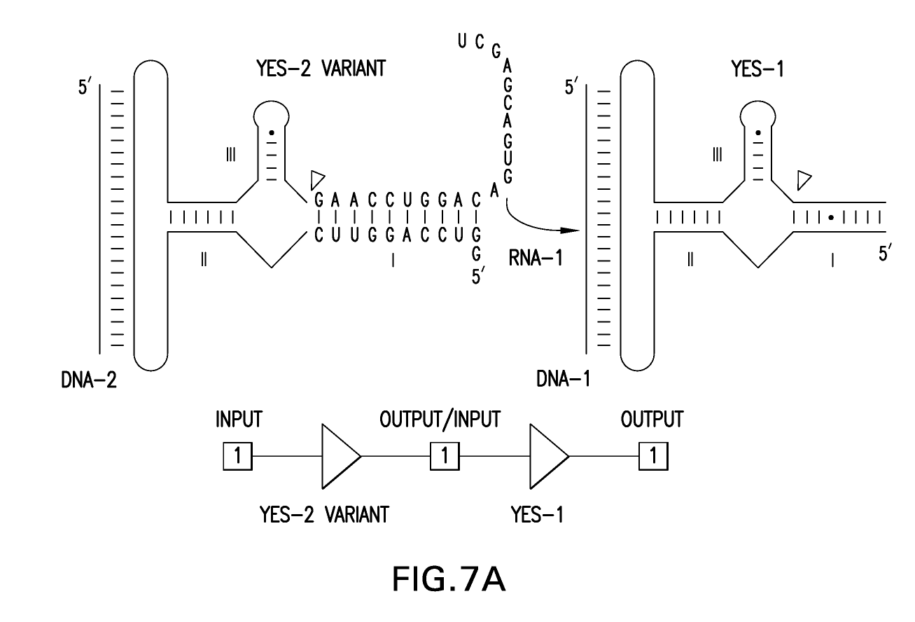

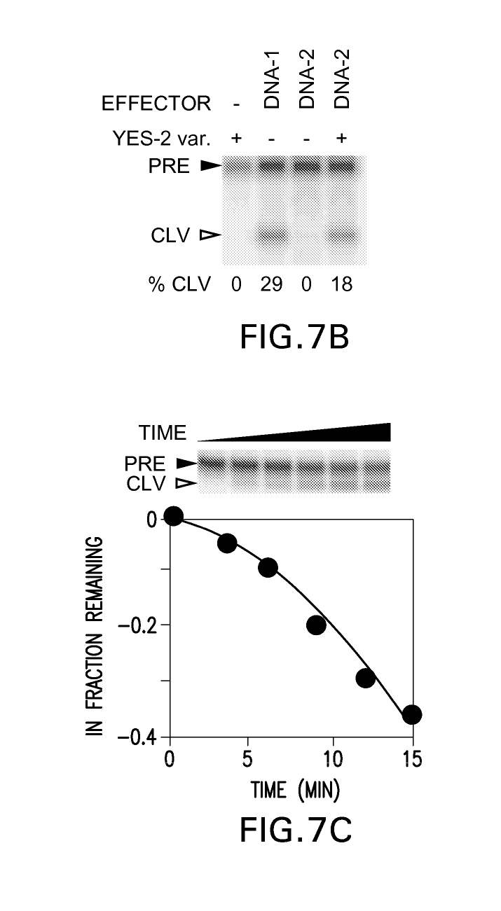

To demonstrate inter-ribozyme communication, construct YES-1 and a variation of construct YES-2 was used to create a simple molecular circuit (FIG. 7a). The sequence and length of YES-2 was altered in stem Ito create a YES-2 variant that generates a new 21-nucleotide 3′ fragment upon self-cleavage (FIG. 7a). This RNA fragment is complementary to the OBS of YES-1, and therefore it should activate the second ribozyme upon cleavage and dissociation from the first ribozyme in the circuit.

This simple molecular signaling pathway was demonstrated using radiolabeled YES-1 with various combinations of unlabeled YES-2 and the oligonucleotides DNA-1 and DNA-2. Although DNA-1 triggers YES-1 cleavage as demonstrated previously (FIG. 2), no cleavage is observed when both ribozymes are simultaneously incubated in the absence of DNA effector (FIG. 7b). This demonstrates that the YES-1 ribozyme is not activated when its RNA-1 signal oligonucleotide remains attached to the YES-2 variant ribozyme. In contrast, the addition of DNA-2 induces YES-1 cleavage only when the YES-2 variant ribozyme is present. Furthermore, the kinetics of YES-1 function as part of the complete signaling pathway are indicative of a lag phase that can be caused by the time required to release RNA-1 from the YES-2 variant upon activation by DNA-2 (FIG. 7c).

These findings are consistent with the design of a ribozyme-signaling pathway in which an activator of the first ribozyme in the series triggers release of an activator of the second ribozyme. These findings show that one can construct more complex molecular circuitries in which oligonucleotide triggers carry out various logic-based ribozyme functions.

### 2. Discussion

In this study, a computational approach has been used to design various oligonucleotide-responsive ribozymes. Of 11 designs constructed based on the general architectures depicted in FIG. 1, all of them functioned as robust RNA switches that exhibit at least three orders of magnitude in rate enhancement and large rate constants for cleavage once activated. This high probability of choosing functional designs is possible because the principles of RNA secondary-structure folding largely follow the simple rules of Watson-Crick base pairing, and the thermodynamic parameters for base-pair interactions are available.

One important advantage of the designs generated by this computational approach is that elements of the constructs can be treated as tunable modules, which makes possible the generation of large numbers of ribozymes with tailored functions by making only a few rational changes. This modularity can be exploited to more rapidly produce variant RNA switches that exhibit distinct effector specificities compared with in vitro selection, which can be repeated for each new target oligonucleotide. Even more sophisticated RNA switches that further mimic the properties of natural riboswitches (e.g., cooperative ligand binding (Mandal 2004)) or that exhibit more complex sensory and control functions can be computationally engineered.

The application of a partition function algorithm for computing base-pairing probabilities (McCaskill 1900) allows RNA engineers to estimate the likelihood that certain secondary structure elements form preferentially over others, and the computing power of desktop systems permits one to survey the full RNA energy landscape for millions of possible sequences with a reasonable expenditure of time. With only a few days of computational time, the scale of the different effector and ribozyme sequences explored can match the initial pool size sometimes used for in vitro selection experiments (˜1015 molecules). Running several computational processes simultaneously further reduces the computational time needed for these analyses to only a few hours.

Slightly larger variants of the ribozyme core (Osborne 2005; Khvorova 2003; De la Pena 2003; Canny 2004) catalyze RNA cleavage with rate constants that are as large as 104 min⁻¹. Therefore, engineered constructs based on these enhanced self-cleaving ribozymes, such as NOT-1 (FIG. 4), can serve as high-speed oligonucleotide-responsive switches for building more complicated computational circuits (Stojanovic 2003a; Stojanovic 2003b) and biosensor devices (Breaker 2004). High-speed RNA switches can also be used as components of designer genetic circuits (Thompson 2002; Yen 2004; Bayer 2005; Isaacs 2004). Multiple different oligonucleotide-sensing ribozymes can be embedded within different reporter gene constructs with overall architectures that enable sensing the expression of mRNAs, noncoding nucleic acids or externally delivered oligonucleotide effectors.

### 3. Methods

i. Design of RNA Switches Possessing Different Logic Functions

The design of oligonucleotide-specific allosteric ribozymes was performed in two stages by adapting an existing random search algorithm for generating DNA libraries for molecular computing (Penchovsky 2003). In stage 1, four different types of hammerhead ribozymes representing AND, OR, YES and NOT Boolean logic functions were selected by computing RNA secondary structures based on the equilibrium partition function as described by McCaskill 44. The use of this approach relies on the application of thermodynamic parameters using essentially the RNAfold source code from the Vienna RNA folding package (Matthews 1999; Hofacker 1994; Hofacker 2003).

For three switch types (AND, OR and YES), constructs were designed such that the nucleotides forming stem II of the hammerhead were held constant, whereas the adjoining loop sequences were randomized. The search algorithm selects for variations of loop sequences that permit portions of the stem II pairing elements to form alternative structure in the absence of effector DNAs. The design of the NOT construct was conducted using the same search algorithm, but the loop sequences adjoining stem III were varied. To simulate the presence of the effector DNA the nucleotides within the OBS elements are defined as having no potential to form secondary structure with the remainder of the construct. Two different states representing the absence and presence of DNA effector were computed for YES and NOT gates. Four different states were computed for OR and AND gates.

In stage 2, the different types of RNA switches were used as matrices for generating sets of ribozyme constructs that have OBS elements with distinct sequences.

For example, the random search algorithm applied for the design of YES gates for stage 1 (1.X) and stage 2 (2.X) is outlined below.

1.1. Generate a new random OBS, from 16 to 22 nucleotides long, over the alphabet of A, U, C, G. The sequences should not have four or more consecutive identical nucleotides.

1.2. Insert the OBS into the predefined RNA sequence GGGCGACCCUGAUGAGCUUGAGUUU(X)16-22AUCAGGCGAAACGGUGAAAGCCGUAGGUUGCCC (SEQ ID NO: 2) that contains the hammerhead motif.

1.3. Fold the sequence obtained and calculate the free energy at 37° C. of the structure using the partition function.

1.4. Determine whether nucleotides 3 through 9 of the hammerhead core (FIG. 1a) participate in base-pair formation in the dominant OFF state secondary structure using the probability dot matrix plot derived from the partition function. If one or more nucleotides 3 through 9 remain unpaired, reject the sequence and go to 1.1.

1.5. Replace the OBS from the structure with the same number of artificial nucleotides that are defined to have no binding properties.

1.6. Fold the sequence and compute the free energies of this ON state based on the partition function.

1.7. Determine if the resulting dominant structure carries all three stems that are required for function of the hammerhead ribozyme using the probability dot matrix plot derived from the partition function. If there is not such a dominant structure, reject the sequence and go to 1.1.

1.8. Determine the percentage of nucleotides in the OBS that participate in base-pairing interactions in the absence of DNA effector. If this value is <30% or >70%, reject the sequence and go to 1.1.

1.9. Compute the free energy of the dominant OFF state secondary structure based on the partition function and determine the gap between the OFF and ON state free energies. If the energy gap is outside the range −6 and −10 kcal mol⁻¹, reject the sequence and go to 1.1. This gap was chosen based on an estimate of the balance between maintaining a stable OFF state and rapidly overcoming this stability via the energy of DNA effector binding.

1.10: Run the program RNAheat (Vienna RNA folding package) for the ON and OFF states. If the dominant structures are not preserved in the range from 20 to 40° C., reject sequence and go to 1.1.

1.11. Compute the ensemble diversity for OFF and ON states. If it does not exceed 9 units (higher values indicate greater secondary structure variability) (Penchovsky 2003), register the sequence as a candidate and go to 1.1. Registered candidates are further processed on an individual basis starting with 2.1.

2.1. Using the secondary structure generated by the stage 1 algorithm wherein the OBS is excluded (see below; parentheses identify base-paired nucleotides), calculate the thermodynamic stability of the structure. Run the program RNAinverse (Vienna RNA folding package) program to generate new RNA sequence that possesses similar secondary structure folding but random sequence of the OBS.

(SEQ ID NO: 3)
((((((((((((((((((((.(..(((......))).
gggcgacccugaugagcuugaguuuXXXXXXXXXXXX
(SEQ ID NO: 4)
))))))))))))).....(((((....))))).))))))))
XXXXXXXXXXaucaggcgaaacggugaaagccguagguugccc

2.2. Determine whether nucleotides 3 through 9 of the hammerhead core (FIG. 1a) participate in base-pair formation of the dominant secondary structure using the probability matrix derived from the partition function. If one or more nucleotides 3 through 9 remain unpaired, reject the RNA sequence and go to 2.1.

2.3. Compute the thermodynamic stability of the dominant secondary structure provided in step 2.2. If the thermodynamic stability of the structure differs by more than ˜5% compared to the candidate RNA sequence provided in step 1.11, reject the sequence and go to 2.1.

2.4. Compute the thermodynamic stability of the OBS bound to its perfectly matched complement RNA. If the thermodynamic stability of the duplex differs by more than ˜5% compared to the candidate OBS provided in step 1.11, reject the sequence and go to 2.1.

2.5. Run the program RNAheat (Penchovsky 2003) for the ON and OFF states. If the dominant structures are not preserved in the range from 20 to 40° C., reject sequence and go to 2.1. The selection of constructs that satisfy this criterion help assure that the RNA switches function at 23° C., despite thermodynamic modeling with data established at 37° C.

2.6. Run the program kinRNA (Flamm 2000) with the RNA sequence derived from stem 2.5. If the dominant structure is not folded within 480 units (larger arbitrary units indicate slower folding), reject sequence and go to 2.1.

2.7. Compute the free energy of the dominant OFF state secondary structure based on the partition function and determine the gap between the OFF and ON state free energies. If the energy gap is more than twofold different than the candidate sequence derived in step 1.11, reject the sequence and go to 2.1.

The procedure applied for the selection of AND, OR and NOT gates utilizes a similar progression of steps. For the AND and OR gates, additional steps were added to compute the structural properties when either one or both effectors are present.

ii. Oligonucleotides

Synthetic DNAs were obtained from Keck Biotechnology Resource Laboratory (Yale University). DNAs were purified by denaturing (8 μM urea) PAGE before use. Template DNAs for in vitro transcription were prepared by overlap extension using SuperScript II reserve transcriptase (Invitrogen) in a reaction volume of 50 μl according to the manufacturer's instructions. Synthetic DNAs corresponding to the nontemplate strand each carried a T7 RNA promoter sequence (TAATACGACTCACTATA (SEQ ID NO: 5)) and 15 nucleotides at the 3′ terminus that overlapped with the synthetic DNA corresponding to the template strand. The resulting double-stranded DNAs were recovered by precipitation with ethanol and used as templates for transcription in vitro (RiboMax; Promega) in the presence of ⁻³²P ATP according to the manufacturer's directions. The transcribed RNAs, produced during a 2-h incubation, were isolated by using denaturing 10% PAGE.

iii. Allosteric Ribozyme Assays

Radiolabeled RNAs were incubated at 25° C. in a reaction solution containing 100 mM Tris-HCl, (pH 8.3 at 23° C.) and 10 mM MgCl². NOT-1 ribozyme assays were conducted at 37° C. in a solution containing 2 mM MgCl², 100 mM KCl, 25 mM NaCl, 50 mM Tris-HCl (pH 7.5 at 37° C.). Ribozyme reactions were initiated by the addition of MgCl² after pre-incubating NOT-1 and tenfold excess DNA-6 (when present) for 5 min in Mg²⁺-free reaction buffer. Reactions were terminated by the addition of an equal volume of gel loading buffer containing 200 mM EDTA. The reaction products were analyzed using denaturing 10% or 6% PAGE and the product bands were detected and quantified using a Phosphorlmager (Molecular Dynamics). Rate constants were determined by plotting the natural logarithm of the fraction of RNA remaining uncleaved versus time, wherein the negative slope of the resulting line reflects k_{obs}.

It is understood that the disclosed method and compositions are not limited to the particular methodology, protocols, and reagents described as these may vary. It is also to be understood that the terminology used herein is for the purpose of describing particular embodiments only, and is not intended to limit the scope of the present invention which will be limited only by the appended claims.

It must be noted that as used herein and in the appended claims, the singular forms “a”, “an”, and “the” include plural reference unless the context clearly dictates otherwise. Thus, for example, reference to “a ribozyme” includes a plurality of such ribozymes, reference to “the ribozyme” is a reference to one or more ribozymes and equivalents thereof known to those skilled in the art, and so forth.

“Optional” or “optionally” means that the subsequently described event, circumstance, or material may or may not occur or be present, and that the description includes instances where the event, circumstance, or material occurs or is present and instances where it does not occur or is not present.

Ranges may be expressed herein as from “about” one particular value, and/or to “about” another particular value. When such a range is expressed, also specifically contemplated and considered disclosed is the range from the one particular value and/or to the other particular value unless the context specifically indicates otherwise. Similarly, when values are expressed as approximations, by use of the antecedent “about,” it will be understood that the particular value forms another, specifically contemplated embodiment that should be considered disclosed unless the context specifically indicates otherwise. It will be further understood that the endpoints of each of the ranges are significant both in relation to the other endpoint, and independently of the other endpoint unless the context specifically indicates otherwise. Finally, it should be understood that all of the individual values and sub-ranges of values contained within an explicitly disclosed range are also specifically contemplated and should be considered disclosed unless the context specifically indicates otherwise. The foregoing applies regardless of whether in particular cases some or all of these embodiments are explicitly disclosed.

Unless defined otherwise, all technical and scientific terms used herein have the same meanings as commonly understood by one of skill in the art to which the disclosed method and compositions belong. Although any methods and materials similar or equivalent to those described herein can be used in the practice or testing of the present method and compositions, the particularly useful methods, devices, and materials are as described. Publications cited herein and the material for which they are cited are hereby specifically incorporated by reference. Nothing herein is to be construed as an admission that the present invention is not entitled to antedate such disclosure by virtue of prior invention. No admission is made that any reference constitutes prior art. The discussion of references states what their authors assert, and applicants reserve the right to challenge the accuracy and pertinency of the cited documents. It will be clearly understood that, although a number of publications are referred to herein, such reference does not constitute an admission that any of these documents forms part of the common general knowledge in the art.

Throughout the description and claims of this specification, the word “comprise” and variations of the word, such as “comprising” and “comprises,” means “including but not limited to,” and is not intended to exclude, for example, other additives, components, integers or steps.

Those skilled in the art will recognize, or be able to ascertain using no more than routine experimentation, many equivalents to the specific embodiments of the method and compositions described herein. Such equivalents are intended to be encompassed by the following claims.

### REFERENCES

1. Breaker, R. R. Natural and engineered oligonucleotides as tools to explore biology. Nature 432, 838-845 (2004).
2. Gold, L., Polisky, B., Uhlenbeck, O.C. & Yarus, M. Diversity of oligonucleotides functions. Annu. Rev. Biochem. 64, 763-797 (1995).
3. Osborne, S. E. & Ellington, A. D. Nucleic acid selection and the challenge of combinatorial chemistry. Chem. Rev. 97, 349-370 (1997).
4. Hamaguchi, N., Ellington, A. & Stanton, M. Aptamer beacons for the detection of proteins. Anal. Biochem. 294, 126-131 (2001).
5. McCauley, T. G., Hamaguchi, N. & Stanton, M. Aptamer-based biosensor arrays for detection and quantification of biological macromolecules. Anal. Biochem. 319, 244-250 (2003).
6. Bock, C. et al. Photoaptamer arrays applied to multiplexed proteomic analysis. Proteomics 4, 609-618 (2004).
7. Soukup, G. A. & Breaker, R. R. Nucleic acid molecular switches. Trends Biotechnol. 17, 469-476 (1999).
8. Soukup, G. A. & Breaker, R. R. Allosteric nucleic acid catalysts. Curr. Opin. Struct. Biol. 10, 318-325 (2000).
9. Silverman, S. K. Rube Goldberg goes (ribo)nuclear? Molecular switches and sensors made from RNA. RNA 9, 377-383 (2003).
10. Seetharaman, S., Zivarts, M., Sudarsan, N. & Breaker, R. R. Immobilized RNA switches for the analysis of complex chemical and biological mixtures. Nat. Biotechnol. 19, 336-341 (2001).
11. Hesselberth, J. R., Robertson, M. P., Knudsen, S. M. & Ellington, A. D. Simultaneous detection of diverse analytes with an aptazyme ligase array. Anal. Biochem. 312, 106-112 (2003).
12. Nahvi, A. et al. Genetic control by a metabolite binding mRNA. Chem. Biol. 9, 1043-1049 (2002).
13. Winkler, W., Nahvi, A. & Breaker, R. R. Thiamine derivatives bind messenger RNAs directly to regulate bacterial gene expression. Nature 419, 952-956 (2002).
14. Mironov, A. S. et al. Sensing small molecules by nascent RNA: a mechanism to control transcription in bacteria. Cell 111, 747-756 (2002).
15. Winkler, W. C., Cohen-Chalamish, S. & Breaker, R. R. An mRNA structure that controls gene expression by binding FMN. Proc. Natl. Acad. Sci. USA 99, 15908-15913 (2002).
16. Sudarsan, N., Barrick, J. E. & Breaker, R. R. Metabolite-binding RNA domains are present in the genes of eukaryotes. RNA 9, 644-647 (2003).
17. Kubodera, T. et al. Thiamine-regulated gene expression of Aspergillus oryzae thiA requires splicing of the intron containing a riboswitch-like domain in the 5′ UTR. FEBS Lett. 555, 516-520 (2003).
18. Winkler, W. C. & Breaker, R. R. Genetic control by metabolite-binding riboswitches. ChemBioChem 4, 1024-1032 (2003).
19. Vitreschak, A. G., Rodionov, D. A., Mironov, A. A. & Gelfand, M. S. Riboswitches: the oldest mechanism for the regulation of gene expression. Trends Genet. 20, 44-50 (2004).
20. Mandal, M. & Breaker, R. R. Gene regulation by riboswitches. Nat. Rev. Mol. Cell Biol. 5, 451-463 (2004).
21. Lewin, A. S. & Hauswirth, W. W. Ribozyme gene therapy: applications for molecular medicine. Trends Mol. Med. 7, 221-228 (2001).
22. Schubert, S. & Kurreck, J. Ribozyme- and deoxyribozymes-strategies for medical applications. Curr. Drug Targets 5, 667-681 (2004).
23. Werstuck, G. & Green, M. R. Controlling gene expression in living cells through small molecule-RNA interactions. Science 282, 296-298 (1998).
24. Grate, D. & Wilson, C. Inducible regulation of the S. cerevisiae cell cycle mediated by an RNA aptamer-ligand complex. Bioorg. Med. Chem. 9, 2565-2570 (2001).
25. Thompson, K. M., Syrett, H. A., Knudsen, S. M. & Ellington, A. D. Group I aptazymes as genetic regulatory switches. BCM Biotechnol. 2, 21 (2002).
26. Suess, B., Fink, B., Berens, C., Stenz, R. & Hillen, W. A theophylline responsive riboswitch based on helix slipping controls gene expression in vivo. Nucleic Acids Res. 32, 1610-1614 (2004).
27. Desai, S. K. & Gallivan, J. P. Genetic screens and selections for small molecules based on a synthetic riboswitch that activates protein translation. J. Am. Chem. Soc. 126, 13247-13254 (2004).
28. Breaker, R. R. Engineered allosteric ribozymes as biosensor components. Curr. Opin. Biotechnol. 13, 31-39 (2002).
29. Ferguson, A. et al. A novel strategy for selection of allosteric ribozymes yields RiboReporter sensors for caffeine and aspartame. Nucleic Acids Res. 32, 1756-1766 (2004).
30. Srinivasan, J. et al. ADP-specific sensors enable universal assay of protein kinase activity. Chem. Biol. 11, 499-508 (2004).
31. Stojanovic, M. N. & Stefanovic, D. Deoxyribozyme-based half-adder. J. Am. Chem. Soc. 125, 6673-6676 (2003).
32. Stojanovic, M. & Stafanovic, D. A deoxyribozyme-based molecular automaton. Nat. Biotechnol. 21, 1069-1074 (2003).
33. Tang, J. & Breaker, R. R. Rational design of allosteric ribozymes. Chem. Biol. 4, 453-459 (1997).
34. Jose, A. M., Soukup, G. A. & Breaker, R. R. Cooperative binding of effectors by an allosteric ribozyme. Nucleic Acids Res. 29, 1631-1637 (2001).
35. Soukup, G. A. & Breaker, R. R. Engineering precision RNA molecular switches. Proc. Natl. Acad. Sci. USA 96, 3584-3589 (1999).
36. Koizumi, M., Kerr, J. K., Soukup, G. A. & Breaker, R. R. Allosteric ribozymes sensitive to the second messengers cAMP and cGMP. Nat. Struct. Biol. 6, 1062-1071 (1999).
37. Robertson, M. P., Knudsen, S. M. & Ellington, A. D. In vitro selection of ribozymes dependent on peptides for activity. RNA 10, 114-127 (2004).
38. Porta, H. & Lizardi, P. M. An allosteric hammerhead ribozyme. Biotechnol. 13, 161-164 (1995).
39. Komatsu, Y., Yamashita, S., Kazama, N., Nobuoka, K. & Ohtsuka, E. Constructuion of new ribozymes requiring short regulator oligonucleotides as a cofactor. J. Mol. Biol. 299, 1231-1243 (2000).
40. Burke, D. H., Ozerova, N. D. & Nilsen-Hamilton, M. Allosteric hammerhead ribozyme TRAPs. Biochemistry 41, 6588-6594 (2002).
41. Wickiser, J. K., Cohen-Chalamish, S., Puskarz, I., Sawiki, B., Ward, D. C. & Breaker, R. R. Engineered oligonucleotides-responsive ribozymes that form structures resembling kissing complexes.
42. Stojanovic, M. N., Mitchell, T. E. & Stefanovic, D. Deoxyribozyme-based logic gates. J. Am. Chem. Soc. 124, 3555-3561 (2002).
43. Wang, D. Y., Lai, B. H., Feldman, A. R. & Sen, D. A general approach for the use of oligonucleotides effectors to regulate the catalysis of RNA-cleaving ribozymes and DNAzymes. Nucleic Acids Res. 30, 1735-1742 (2002).
44. McCaskill, J. S. The equilibrium partition function and base pair binding probabilities for RNA secondary structure. Biopolymers 29, 1109-1119 (1990).
45. Bonhoeffer, S., McCaskill, J. S., Stadler, P. F. & Schuster, P. RNA multi-structure landscapes. A study based on temperature dependent partition functions. Eur. Biophys. J. 22, 13-24 (1993).
46. Russell, R. et al. Exploring the folding landscape of a structured RNA. Proc. Natl. Acad. Sci. USA 99, 155-160 (2002).
47. Woodson, S. A. Folding mechanisms of group I ribozymes: Role of stability and contact order. Biochem. Soc. Trans. 30, 1166-1169 (2002).
48. Sosnick, T. R. & Pan, T. RNA folding: Models and perspectives. Curr. Opin. Struct. Biol. 13, 309-316 (2003).
49. Flamm, C., Fontana, W., Hofacker, I. & Schuster, P. RNA folding kinetics at elementary step resolution. RNA 6, 325-338 (2000).
50. Flamm, C., Hofacker, I. L., Maurer-Stroh, Stadler, P. F. & Zehl, M. S. Design of multi-stable RNA molecules. RNA 7, 254-265 (2001).
51. Forster, A. C. & Symons, R. H. Self-cleavage of plus and minus RNAs of a virusoid and a structural model for the active sites. Cell 49, 211-220.
52. Hertel, K. J. et al. Numbering system for the hammerhead. Nucleic Acids Res. 20, 3252 (1992).
53. Osborne, E. M., Schaak, J. E. & DeRose, V. J. Characterization of a native hammerhead ribozyme derived from schistosomes. RNA 11, 187-196 (2005).
54. Khvorova, A., Lescoute, A., Westhof, E. & Jayasena, S. D. Sequence elements outside the hammerhead ribozyme catalytic core enable intracellular activity. Nat. Struct. Biol. 10, 708-712 (2003).
55. De la Pena, M., Gago, S. & Flores, R. Peripheral regions of natural hammerhead ribozymes greatly increase their self-cleavage activity. EMBO J. 22, 5561-5570 (2003).
56. Canny, M. D. et al. Fast cleavage kinetics of a natural hammerhead ribozyme. J. Am. Chem. Soc. 126, 10848-10849 (2004).
57. Mandal, M. et al. A glycine-dependent riboswitch that uses cooperative binding to control gene expression. Science 306, 275-279 (2004).
58. Yen, L. et al. Exogenous control of mammalian gene expression through modulation of RNA self-cleavage. Nature 431, 471-476 (2004).
59. Bayer, T. S. & Smolke, C. D. Programmable ligand-controlled riboregulators of eukaryotic gene expression. Nat. Biotechnol. 23, 337-343 (2005).
60. Isaacs, F. J. et al. Engineered riboregulators enable post-transcriptional control of gene expression. Nat. Biotechnol. 22, 841-847 (2004).
61. Penchovsky, R. & Ackermann, J. DNA library design for molecular computation. J. Comput. Biol. 10, 215-229 (2003).
62. Mathews, D., Sabina, J., Zucker, M. & Turner, H. Expanded sequence dependence of thermodynamic parameters provides robust prediction of RNA secondary structure. J. Mol. Biol. 288, 911-940 (1999).
63. Hofacker, I. L. et al. Fast folding and comparison of RNA secondary structures. Monatsh. Chem. 125, 167-188 (1994).
64. Hofacker, I. L. Vienna RNA secondary structure server. Nucleic Acids Res. 31, 3429-3431 (2003).
65. U.S. Pat. No. 4,683,195, issued Jul. 28, 1987.
66. U.S. Pat. No. 4,683,202, issued Jul. 28, 1987.
67. U.S. Pat. No. 4,800,159, issued Jan. 24, 1989.
68. U.S. Pat. No. 4,883,750, issued Nov. 28, 1989.
69. U.S. Pat. No. 4,987,071, issued Jan. 22, 1991.
70. U.S. Pat. No. 5,297,721, issued Jan. 18, 1994.
71. U.S. Pat. No. 5,334,711, issued Aug. 2, 1994.
72. U.S. Pat. No. 5,354,855, issued Oct. 11, 1994.
73. U.S. Pat. No. 5,455,166, issued Oct. 3, 1995.
74. U.S. Pat. No. 5,631,359, issued May 20, 1997.
75. U.S. Pat. No. 5,648,211, issued Jul. 15, 1997.
76. U.S. Pat. No. 5,712,124, issued Jan. 27, 1998.
77. U.S. Pat. No. 5,744,311, issued Apr. 28, 1998.
78. PCT/US87/00880.
79. PCT/US88/10315.
80. PCT/US89/01025.
81. WO 89/06700
82. WO 90/07641
83. WO 91/03162
84. WO 92/07065.
85. WO 93/15187.
86. WO 93/23569
87. WO 94/02595
88. WO 94/13688
89. EP 0329822.
90. EP 0360257
91. EP 320308.
92. EP 92110298.4.
93. Great Britian Pat. Appl. No. 2202328.
94. Birikh, Heaton and Eckstein, “The structure, function and application of the hammerhead ribozyme,” Eur. J. Biochem., 245:1-16, 1997.
95. Chee, Yang, Hubbell, et al., “Accessing genetic information with high-density DNA arrays,” Science, 274:610-614, 1996.
96. Chen et al., “Multitarget-ribozyme directed to cleave at up to nine highly conserved HIV-1 env RNA regions inhibits HIV-1 replication--potential effectiveness against most presently sequenced HIV-1 isolates,” Nucl. Acids Res., 20:4581-4589, 1992.
97. Collins and Olive, “Reaction conditions and kinetics of self-cleavage of a ribozyme derived from Neurospora VS RNA,” Biochem., 32(11):2795-2799, 1993.
98. Collins, Jacks and Pavletich, “The cell cycle and cancer,” Proc. Natl. Acad. Sci. USA, Daiger, Rossiter, Greenberg, Christoffels and Hide, “Data services and software for identifying genes and mutations causing retinal degeneration,” Invest. Ophthalmol. Vis. Sci., 39:S295, 1998.
99. Drenser, Timmers, Hauswirth and Lewin, “Ribozyme-targeted destruction of RNAs associated with ADRP,” Inv. Ophth. Vis. Sci., 39:681-689, 1998.
100. Dropulic, Lin, Martin, Jeang, “Functional characterization of a U5 ribozyme: intracellular suppression of human immunodeficiency virus type 1 expression,” J. Virol., 66(3):1432-1441, 1992.
101. Eisen, Spellman, Brown and Botstein, “Cluster analysis and display of genome-wide expression patterns,” Proc. Nat'l Acad. Sci. USA, 95:14863-14868, 1998.
102. Fedor and Uhlenbeck, “Substrate sequence effects on ‘hammerhead’ RNA catalytic efficiency,” Proc. Nat'l Acad. Sci. USA, 87:1668-1672, 1990.
103. Guerrier-Takada, Gardiner, Marsh, pace, Altman, “The RNA moiety of ribonuclease P is the catalytic subunit of the enzyme,” Cell, 35:849, 1983.
104. Hampel and Tritz, “RNA catalytic properties of the minimum (−)s TRSV sequence,” Biochem., 28:4929, 1989.
105. Hampel, Tritz, Hicks, Cruz, “'Hairpin' catalytic RNA model: evidence for helices and sequence requirement for substrate RNA,” Nucl. Acids Res., 18:299, 1990.
106. Hirsch, Gaugler, Deagostini-Bauzin, Bally-Cuif and Gordis, “Identification of positive and negative regulatory elements governing cell-type-specific expression of the neural-cell-adhesion-molecule gene,” Mol. Cell. Biol., 10:1959, 1990.
107. Joyce, “RNA evolution and the origins of life,” Nature, 338:217-244, 1989.
108. Kief and Warner, “Coordinate control of syntheses of ribosomal ribonucleic acid and ribosomal proteins during nutritional shift-up in Saccharomyces cerevisiae,” Mol. Cell Biol., 1:1007-1015, 1981.
109. L'Huillier, David, Bellamy, “Cytoplasmic delivery of ribozymes leads to efficient reduction in alpha-lactalbumin mRNA levels in C1271 mouse cells,” EMBO J., 11(12):4411-4418, 1992.
110. Liang and Pardee, “Differential display. A general protocol,” Methods Mol. Biol., 85:3-11, 1997.
111. Mager and Planta, “Coordinate expression of ribosomal protein genes in yeast as a function of cellular growth rate,” Mol. Cell Biochem., 104:181-187, 1991.
112. Michel and Westhof, “Modeling of the three-dimensional architecture of group I catalytic introns based on comparative sequence analysis,” J. Mol. Biol., 216:585-610, 1990.
113. Muesing, Smith and Capon, “Regulation of mRNA accumulation by a human immunodeficiency virus trans-activator protein,” Cell, 48:691, 1987.
114. Ohkawa, Yuyama, Taira, “Activities of HIV-RNA targeted ribozymes transcribed from a ‘shot-gun’ type ribozyme-trimming plasmid,” Nucl. Acids Symp. Ser., 27:15-16, 1992.
115. Ojwang, Hampel, Looney, Wong-Staal, Rappaport, “Inhibition of human immunodeficiency virus type 1 expression by a hairpin ribozyme,” Proc. Natl. Acad. Sci. USA, 89(22):10802-10806, 1992.
116. Perrotta and Been, “Cleavage of oligoribonucleotides by a ribozyme derived from the hepatitis delta virus RNA sequence,” Biochem., 31(1):16, 1992.
117. Pieken, Olsen, Benseler, Aurup, Eckstein, “Kinetic characterization of ribonuclease-resistant 2′-modified hammerhead ribozymes,” Science, 253 (5017):314, 1991.
118. Rossi, Elkins, Zaia, Sullivan, “Ribozymes as anti-HIV-1 therapeutic agents: principles, applications, and problems,” AIDS Res. Hum. Retrovir., 8(2):183, 1992.
119. Roth, Hughes, Estep and Church, “Finding DNA regulatory motifs within unaligned noncoding sequences clustered by whole-genome mRNA quantitation,” Nat. Biotechnol., 16:939-945, 1998.
120. Sambrook et al., Molecular Cloning: A Laboratory Manual, Cold Spring Harbor Laboratory, Cold Spring Harbor, N.Y., 1989.
121. Sarver, Cantin, Chang, Zaia, Ladne, Stephens, Rossi, “Ribozymes as a potential anti-HIV-1 therapeutic agents,” Science, 247(4947):1222-1225, 1990.
122. Saville and Collins, “A site-specific self-cleavage reaction performed by a novel RNA in Neurospora mitochondria,” Cell, 61(4):685-696, 1990.
123. Saville and Collins, “RNA-mediated ligation of self-cleavage products of a Neurospora mitochondrial plasmid transcript,” Proc. Natl. Acad. Sci. USA, 88(19):8826-8830, 1991.
124. Scanlon, Jiao, Funato, Wang, Tone, Rossi, Kashani-Sabet, “Ribozyme-mediated cleavage of c-fos mRNA reduces gene expression of DNA synthesis enzymes and metallothionein,” Proc. Natl. Acad. Sci. USA, 88(23):10591-10595, 1991.
125. Simmons et al., J. Histochem., 12:169-181, 1989.
126. Taira, Nakagawa, Nishikawa, Furukawa, “Construction of a novel RNA-transcript-trimming plasmid which can be used both in vitro in place of run-off and (G)-free transcriptions and in vivo as multi-sequences transcription vectors,” Nuc. Acids Res., 19(19):5125-5130, 1991.
127. Tamayo, Slonim, Mesirov, et al., “Interpreting patterns of gene expression with self-organizing maps: methods and application to hematopoietic differentiation,” Proc. Nat'l Acad. Sci. USA, 96:2907-2912, 1999.
128. Usman and Cedergren, “Exploiting the chemical synthesis of RNA,” Trends Biochem. Sci., 17(9):334, 1992. [0549] Usman et al., J. Am. Chem. Soc., 109:7845-7854, 1987.
129. Ventura, Wang, Ragot, Perricaudet, Saragosti, “Activation of HIV-specific ribozyme activity by self-cleavage,” Nuc. Acids Res., 21:3249-3255, 1993.
130. Zolotukhin, Potter, Hauswirth, Guy and Muzyczka, “A ‘humanized’ green fluorescent protein cDNA adapted for high-level expression in mammalian cells,” J. Virol., 70:4646-4654, 1996.
131. SEQUENCE LISTING

SEQ ID NO: 1
CTCATCAGC
SEQ ID NO: 2
GGGCGACCCUGAUGAGCUUGAGUUU(N)UCAGGCGAAACGGUGAAAGC
CGUAGGUUGCCC
SEQ ID NO: 3
gggcgacccugaugagcuugaguuuN
SEQ ID NO: 4
Naucaggcgaaacggugaaagccguagguugccc
SEQ ID NO: 5
TAATACGACTCACTATA

We claim:

1. A method for designing a nucleic acid switch, the method comprising
a. generating a random oligonucleotide binding sequence;
b. generating a potential nucleic acid switch for molecular computing, wherein the potential nucleic acid switch comprises core sequences and the oligonucleotide binding sequence, wherein a nucleic acid consisting of the core sequences can form a predetermined active structure;
c. utilizing an algorithm to predict secondary structure of the potential nucleic acid switch;
d. determining if a predetermined portion of the core sequences forms a predetermined structure in the predicted secondary structure of step (c);
e. if the predetermined structure of step (d) is formed, then utilizing an algorithm to predict secondary structure of the potential nucleic acid switch with the oligonucleotide binding sequences replaced with nucleotides defined to have no binding properties, otherwise, repeating steps (a) through (e);
f. determining if the predicted secondary structure comprises a predetermined active structure;
g. if the predetermined active structure of step (f) is formed, then generating a new potential nucleic acid switch comprising the same core sequences and a new random oligonucleotide binding sequence, wherein the new potential nucleic acid switch forms a similar predicted secondary as the predicted secondary structure of step (c), otherwise, repeating steps (a) through (g);
h. determining if a predetermined portion of the core sequences forms a predetermined structure in the predicted secondary structure of step (c);
i. if the predetermined structure of step (h) is formed, then computing the thermodynamic stability of the predicted secondary structure of step (h), otherwise, repeating steps (a) through (i);
j. if the thermodynamic stability of step (i) differs by more than a threshold value from the thermodynamic stability of the predicted secondary structure of step (c), repeat steps (a) through (j);
k. computing the thermodynamic stability of the oligonucleotide binding sequence of step (g) when bound to a perfectly matched complementary RNA;
l. if the thermodynamic stability of step (k) differs by more than a threshold value from the thermodynamic stability of the oligonucleotide binding sequence of step (a) when bound to a perfectly matched complementary RNA, repeat steps (a) through (l); and
m. producing a nucleic acid switch comprising the sequence of the new potential nucleic acid switch of step (g).

2. A method of designing a nucleic acid switch, comprising:
a. generating an RNA library of potential nucleic acid switches for molecular computing;
b. utilizing an algorithm to predict secondary structure of the potential nucleic acid switches in the presence and absence of a target ligand;
c. determining the difference in the secondary structure of the RNA in the presence and the absence of the target ligand;
d. comparing the difference in the secondary structure in the presence and absence of the target ligand to a standard; and
e. selecting those potential nucleic acid switches which meet the standard; thereby designing a nucleic acid switch.

3. The method of claim 1, wherein the nucleic acid switch is a riboswitch.

4. The method of claim 1, wherein the algorithm is a partition function algorithm.

5. The method of claim 3, wherein thermodynamic search parameters are used in the algorithm.

6. The method of claim 4, wherein RNAfold source code from the Vienna RNA folding package is used in the algorithm.

7. The method of claim 2, wherein base-pairing probabilities for the RNA and target ligand are computed.

8. The method of claim 2, wherein the target ligand is an oligonucleotide.

9. The method of claim 2, wherein the RNA forms a dominant secondary structure in the absence of the target ligand and a different secondary structure in the presence of the target ligand.

10. The method of claim 2, wherein the RNA forms a dominant secondary structure in the presence of the target ligand and a different secondary structure in the absence of the target ligand.

11. The method of claim 2, wherein the RNA forms a dominant secondary structure in the absence of two distinct target ligands, and a different secondary structure in the presence of both distinct target ligands.

12. The method of claim 11, wherein the presence of only one of the distinct target ligands does not cause the RNA to form a different secondary structure.

13. The method of claim 2, wherein the RNA forms a dominant secondary structure in the absence of both of two distinct target ligands, and a different secondary structure in the presence of one or the other target ligands.

14. The method of claim 2, wherein the algorithm computes one or more possible secondary structures for the RNA molecule.

15. The method of claim 14, wherein the secondary structures are computed as a function of temperature.

16. The method of claim 2, wherein the potential ribozyme has a modular architecture.

17. The method of claim 16, wherein the modular architecture allows an oligonucleotide binding site to be computationally altered.

18. The method of claim 2, wherein after identifying a potential ribozyme, sequences found in the oligonucleotide binding site of the potential ribozyme are varied, thereby designing a second library of potential ribozymes.

19. The method of claim 2, wherein the potential ribozyme is a hammerhead ribozyme.

20. The method of claim 1, further comprising determining the percentage of nucleotides in the oligonucleotide binding sequences that participate in base-pairing in the predicted secondary structure of step (c) and, if the percentage is not within a predetermined range then repeating the method starting with step (a).

21. The method of claim 1, further comprising comparing the free engery of the predicted secondary structure of step (c) and of the predicted secondary structure of step (e), wherein if the energy gap is not within a predetermined range then repeating the method starting with step (a).

22. The method of claim 1, further comprising utilizing an algorithm to determine if the predicted secondary structure of step (c) and the predicted secondary structure of step (e) are preserved within a predetermined temperature range, wherein if either or both the predicted secondary structure of step (c) or the predicted secondary structure of step (e) are not preserved within the predetermined temperature range then repeating the method starting with step (a).

23. The method of claim 1, further comprising computing the ensemble diversity for the predicted secondary structure of step (c) and for the predicted secondary structure of step (e), wherein if the ensemble diversity for either or both the predicted secondary structure of step (c) or the predicted secondary structure of step (e) exceeds a predetermined ensemble diversity then repeating the method starting with step (a).

24. The method of claim 1, further comprising utilizing an algorithm to predict secondary structure of the new potential nucleic acid switch of step (g) with the oligonucleotide binding sequences replaced with nucleotides defined to have no binding properties; utilizing an algorithm to determine if the predicted secondary structure of step (g) and the predicted secondary structure of the new potential nucleic acid switch of step (g) with the oligonucleotide binding sequences replaced with nucleotides defined to have no binding properties are preserved within a predetermined temperature range, wherein if either or both the predicted secondary structure of step (c) or the predicted secondary structure of step (e) are not preserved within the predetermined temperature range then repeating the method starting with step (a).

25. The method of claim 21, further comprising utilizing an algorithm to predict secondary structure of the new potential nucleic acid switch of step (g) with the oligonucleotide binding sequences replaced with nucleotides defined to have no binding properties; comparing the free energy of the predicted secondary structure of step (g) and of the predicted secondary structure of the new potential nucleic acid switch of step (g) with the oligonucleotide binding sequences replaced with nucleotides defined to have no binding properties, wherein if the energy gap is more than twofold different from that energy gap of claim 21 then repeating the method starting with step (g).

26. A computer program embodied on a computer-readable medium for designing a ribozyme, comprising an algorithm to predict secondary structure of an RNA molecule in the presence and absence of a target ligand.

27. The computer program of claim 26, wherein the program is further able to vary the sequences of the oligonucleotide binding site of the potential ribozyme.

28. A process embodied in an instruction signal of a computing device for generating a potential ribozyme, comprising an algorithm to predict secondary structure of an RNA molecule in the presence and absence of a target ligand.
